(19) United States
(12) Patent Application Publication
(10) Pub. No.: US 2009/0254206 A1
(43) Pub. Date: Oct. 8, 2009

(54) System and method for composing individualized music

(76) Inventors: David Snowdon, South Woodford (GB); Lawrence Ball, London (GB)

Correspondence Address: Thomas McNally, PO BOX 20188, Huntington Station, NY, 11746, US

(21) Appl. No.: 12/080,384

(22) Filed: Apr. 2, 2008

(51) Int. Cl. G06F 17/00

(52) U.S. Cl. 700/94

(57) ABSTRACT

A system, apparatus, and method for generating audio information based upon information corresponding to a user. The system including one or more controllers which input user information, form one or more streams of information based upon the user information, create a pattern in accordance with the user information, and generate audio information based upon the pattern. Further, the one or more controllers can optionally communicate with each other using wired or wireless (e.g., a cellular) networking systems.

### FIELD OF THE INVENTION

The present invention relates generally to a system, apparatus, and method which generates personalized information, and more particularly to a system, apparatus, and method which generates a music composition based upon information such as, for example, images and/or sound files.

### BACKGROUND OF THE INVENTION

With the advent of the Internet, user socialization websites have become common. In these websites, individuals may post personal information such as education, accomplishments, employment status, ideals, and favorite songs, places, friends, etc. Viewers of these websites may then learn more about a selected individual or entity by accessing, for example, a page including the user's information. For example, viewers may select items on the person's web page (e.g., links, etc.) to access other information about the person. For example, a viewer of “Beth's” web page may view information that is unique to Beth such as Beth's image, her favorite songs, etc. However, although this information, such as, for example, Beth's image, may be unique to Beth, it may be desirable to associate other unique information with her to further personalize her webpage. Accordingly, user personalization may be achieved by including information which is composed using a feature unique to Beth such as, for example, Beth's image.

Accordingly, there is a need for a system, apparatus, and method for determining, forming, and providing information unique to a user. Further, there is a need for a social networking system, apparatus, and method which can form and provide information (e.g., musical tunes, etc.) unique to a user via a network.

### SUMMARY OF THE INVENTION

Therefore, it is an object of the present invention to solve the above-noted and other problems of conventional social networking methods and to provide a system, apparatus, and method which can generate and provide individualized (or unique) information corresponding to a user's input. The system can further output this information directly (e.g., via one or more audio outputs such as, for example, speakers, etc., and/or one or more displays—which are not shown).

Thus, according to an aspect of the present invention, there is provided a system, apparatus, and method which can compose unique pieces of music when provided with, for example, a set of images, sound files (e.g., a user's voice or other sound), user selections (e.g., a rhythm, etc.), etc. The system may include, for example, a user interface such as, for example, one or more displays (either directly or remotely mounted for example, via a network such as a LAN, a WAN, the Internet, etc.), a telephonic interface, or other suitable interface, as desired. Further, the method of the present invention can run on one or more of a server, a workstation (e.g., a personal computer (PC)), a personal digital assistant (PDA), a mobile station (MS) such as a cellular phone, and/or other suitable computing devices, as desired. These devices may operate independently of each other or may communicate to one or more other devices via, for example, a wired and/or wireless network such as, for example, a LAN, WAN, the Internet, a cellular (telephone) network, etc.

It is also an aspect of the present invention to operate perform the method of the present invention on one or more computers which can, for example, operate via a network (e.g., wired or wireless) such as, for example, a LAN, a WAN, the Internet, a cellular communication network, and/or combinations thereof.

Although the musical ability of users may vary, outputs of the present invention are substantially independent of the musical ability of a user. Accordingly, the system, apparatus and method of the present invention forms and outputs data which is independent of a person's musical ability.

It is a further aspect of the present invention to provide a core music composition engine which processes an input stream of floating point numbers and generates a pattern representing a musical composition. The method can include the steps of collecting user input information such as, for example, sound and/or image data. This user input information may include one or more images, an audio sample, such as, for example, a person's voice, a sample of any sound, a rhythm, etc. The user input information can include files which may be provided by the user (e.g., formed and/or uploaded by the user), files selected from a predetermined list (e.g., provided by the system), etc. The user can also record audio (e.g., the user's voice, a song, rhythm, etc.) and/or graphic files (e.g., an image such as the user's face, etc.). Accordingly, the system, apparatus, and/or method can provide the user with an interface (e.g., a graphic and/or audio) to select desired information to be input and/or to record information, if desired.

It is a further aspect of the present invention to provide a system which can convert user input information to one or more information streams each of which can include, for example, floating point numbers or some other suitable numbering scheme (e.g., integers). For example, the floating point numbers can have a range which is between 0.0 and 1.0. However, other ranges can also be used, if desired. The system processes the one or more information streams, using, for example, an inference engine, and creates a pattern e.g., in a format such as, for example, XML, which represents a musical composition. The system processes the pattern to create musical notes (e.g., in an encoded in MIDI format) and optionally converts the musical notes to a suitable format such as an MP3 (MPEG-1 Audio Layer 3) encoded audio file and effects processing (e.g., audio compression). The information produced (e.g., the MIDI and/or MP3 format information) can be optionally directly output (e.g., via the speaker and/or display) or can be transmitted via, for example, a network such as a LAN, WAN, the Internet, a mobile communication network, a cellular (e.g., telephone) network, etc. to one or more users. The system according to the present invention may use one or more processors and may be located in one or more locations. For example, a data base containing information such as, for example, user input information, produced data, musical notes, etc, may be located at a first location and a processor may be located at another location and communicate with the other devices such as, for example, the data base using a suitable means via the network. Further, a user may communicate with the system, apparatus, and/or method via wired and/or wireless communication means (e.g., a PC, a PALM, a cellular telephone, etc.).

Accordingly, it is an aspect of the present invention to provide a system, apparatus, and method for generating audio information based upon information corresponding to a user. The system can include one or more controllers which input user information and form one or more streams of information based upon the user information, create a pattern in accordance with the user information, and generate audio information based upon the pattern. Further, the one or more controllers may communicate with each other using wired and/or wireless (e.g., a cellular) networking systems.

According to the present invention, disclosed is a system and apparatus for generating audio information, including one or more controllers which input user information, form one or more streams of information based upon the user information, create a pattern in accordance with the user information, and generate audio information based upon the pattern. The user information can include at least one of audio and visual data and the audio data can include at least one of an image, a voice, and a rhythm. According to the system, the one or more streams can include floating point numbers. Further, the one or more streams can range from 0 to 1 (or other suitable numbers which can be normalized if desired). Further, the system can include an interference engine which processes the one or more streams of information. The pattern can be based upon a musical composition corresponding to a music template. Further, the controller can operate so as to convert the generated audio information into audio information having a desired file format which can include a MIDI file or a text file corresponding to a musical score.

It is a further aspect of the present invention to provide a method for generating audio information using at least one controller, the method including the steps of: inputting, using the at least one controller, user information; forming, using the at least one controller, one or more streams of information based upon the user information; creating, using the at least one controller, a pattern in accordance with the user information; and generating, using the at least one controller, the audio information based upon the pattern. According to the method, the user information can include at least one of audio and visual data. Further, the audio data can include at least one of an image, a voice, and a rhythm. Moreover, the one or more streams include floating point numbers which can, for example, have a range of between 0 and 1. The method may also include processing, using an interference engine, the one or more streams of information and the pattern can be based upon a musical composition corresponding to a music template. It is a further aspect of the method to convert, using the at least one controller, the generated audio information into audio information having a desired file format such as, for example, a MIDI file or a text file corresponding to a musical score.

It is a further aspect of the present invention to provide a method performed by a system including at least one controller, the method including receiving, by the at least one controller, voice information, inputting, by the at least one controller, image information, receiving, by the at least one controller, at least one of sound information and rhythm information, processing the received voice information, image information, and the at least one of sound information and rhythm information, and forming a musical composition based upon the one or more of the received voice information, image information, sound information and rhythm information. The method can also include forming a string of floating point numbers based upon at least one of the voice, image, sound and rhythm information.

Additional advantages of the present invention include the incorporation of features that reduce the complexity and cost of manufacturing.

### BRIEF DESCRIPTION OF THE DRAWINGS

The invention is herein described, by way of example only, with reference to the accompanying drawings, wherein:

FIG. 1 is a flow chart illustrating a method according to the present invention;

FIG. 2 is a flow chart illustrating a musical structure process according to the present invention;

FIG. 3 is a block diagram of an embodiment of the system according to the present invention for interfacing with a network such as the Internet;

FIG. 4 is a flowchart illustrating a portrait sitting process according to the present invention;

FIG. 5A is a screen shot illustrating an information display according to a process of the present invention;

FIG. 5B is a screen shot illustrating a log-in page according to a process of the present invention;

FIG. 6 is a screen shot illustrating an information page according to a process of the present invention;

FIG. 7 is a screen shot illustrating an introduction page according to a process of the present invention;

FIG. 8 is a screen shot illustrating a browser test page according to a process of the present invention;

FIGS. 9A-9C are screen shots illustrating voice selection upload screens according to a process of the present invention;

FIGS. 10A-10B are screen shots illustrating image upload screens according to a process of the present invention;

FIGS. 11A-11C are screen shots illustrating sound selection screens according to a process of the present invention;

FIGS. 12A-12C are screen shots illustrating rhythm selection screens according to a process of the present invention;

FIGS. 13A-13B are screen shots illustrating listen-to-music screens according to a process of the present invention;

FIG. 14 is a block diagram illustrating the system according to an embodiment of the present invention; and

FIGS. 15A-15F are graphs illustrating the output of a harmonics maths process according to the present invention.

### DETAILED DESCRIPTION OF THE INVENTION

Preferred embodiments of the present invention will now be described in detail with reference to the drawings. For the sake of clarity, certain features of the invention will not be discussed when they would be apparent to those with skill in the art. If desired, one or more steps and/or features of the present invention may be deleted and/or incorporated into other steps and/or features. Further, the method may be performed by one or more controllers operating at one or more locations and/or communicating with each other via wired and/or wireless connections.

When referring to musical instruments of a certain type (e.g., a guitar, a piano, drum, clarinet, etc.), it is assumed the instruments can be synthesized and/or actual sound clips may be used.

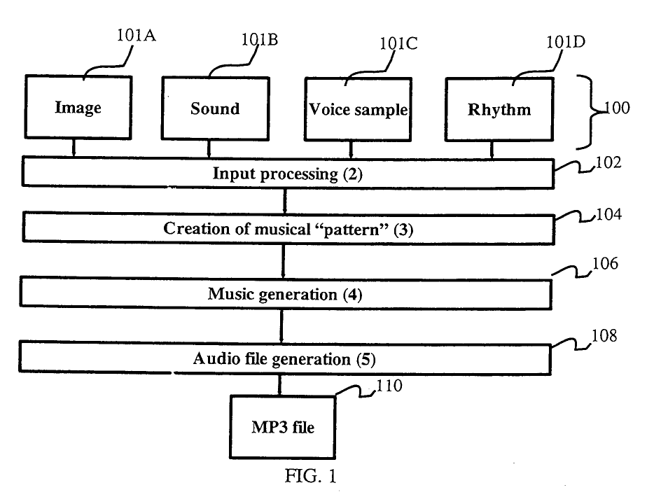

A flow chart illustrating a method according to the present invention is shown in FIG. 1A. In step 100, user information, such as, for example, one or more of image information 101A, audible (e.g., sound) information 101B, voice information 101C, and/or rhythm information 101D, can be input (either automatically or by, for example, a user) into the system (via, for example, such as, for example, a JAVA applet operating in a user's computer) for processing. The user information can be pre-stored (e.g., on a user's computer and/or another data base such as database 324, etc.), or can be recorded in real time (e.g., using an audio and/or video link, etc.). The user information can be automatically selected (e.g., by the system and/or apparatus (hereinafter system)) or can be selected by a user and uploaded to the system for processing.

In step 102, an input processor (not shown) performs input processing on the received user information. Music produced by the method of the present invention can vary according to various input information that is input into the system (e.g., into the input processor, etc.). Depending upon processing methods, similar (but not the same) inputs should yield similar outputs (i.e., results). However, similar (but not identical) information input into the system may include files which have different values for a particular sample (e.g., a sound sample, a pixel, etc.). Thus, when processing these similar (but not identical) samples, one or more statistical processes are used to produce a representation that contains sufficient information to drive a subsequent composition process and generate similar output results for similar (if not the same) inputs.

For example, when processing images, a colorfulness measure may be determined by sampling the image a number of times (e.g., 2000, etc.) at, for example, random locations, to determine how many colors are present. A colorfulness measure of 1.0 can be used to indicate that all samples returned a different colorfulness measure, while a colorfulness measure of 0.0 can indicate that all samples returned the same color. Thus, the colorfulness measure can include a single digit as opposed to a stream of digits as used in other values according to the present invention. Further, image luminance (e.g., the average of red, green and blue components of pixels) can also be determined by, for example, sampling in a pattern such as, for example, a spiral pattern working from the center of the image to the outside of the image. The results can then be normalized to fall within the range of, for example, 0.0-1.0 with 0.0 indicating minimum luminance (i.e., black) and 1.0 indicating maximum luminance (i.e., white).

When processing audio information (e.g., sound information), inaudible areas (e.g., silent areas at the beginning and end of a recording) can be recognized and skipped. The audio information can be divided into overlapping segments of a given length (e.g., 1/10 of a second). A Fourier analysis can then be performed on each of the segments to produce an output in bands corresponding to a Bark scale and the results are output as floating point numbers which correspond to each of the segments of the input audio information. As used in the present invention, the Bark scale typically specifies 24 frequency bands. The system determines a Fourier transform for a given segment of audio information and energy is determined for each of the 24 frequency bands corresponding to the Bark scale. For each frequency band in the Bark scale, the system: determines a range of FFT (fast Fourier transform) results that fit in the frequency bands; sums the squares of a real portion (as opposed to an imaginary portion of complex numbers) of the FFT results in the frequency band; and divides the summed squares by the number of FFT samples within the frequency band. Once the system has computed the values for the entire audio file, the system can normalize the results to ensure that all values are within a specific range such as, for example, 0.0-1.0.

When processing rhythms, a power variation of the input signal is analyzed so as to identify pulsed of more than an average strength and are set as “beats.” Then, a variation in time between each of the beats is determined and the results normalized so that they fall into the range of 0.0-1.0 (where, for example, 0.0 represents the shortest delay and 1.0 represents the longest delay—of the input rhythms during a certain time frame).

According to the present invention, the input processor can process various types (e.g., audio-, image-, video-, and/or motion-types) of information input thereto. For example, the input information may include audio, image, video, graphic, motion, text, motion/position, etc. information and/or combinations thereof. This information may be input in real time or may include saved (e.g., an image file, etc.) information. The input (e.g., a real-time voice input or a saved file, etc.) can be input or selected for input by the system and/or the user, as desired. Accordingly, the input processor can include one or more corresponding input processors which are optionally provided for each type of input information. Thus, for example, textual information may be processed by a text input processor while a motion tracker input (e.g., generated by a game system, such as a Nintendo™ Wii™ remote control) may be processed by a motion-tracker input processor (not shown). Accordingly, the system may include means for determining the type of input information and for determining which of the corresponding input processors to use. It is also envisioned that one or more of the input processors may be formed integrally with and/or incorporated into another input processor.

Referring back to steps 101A-D, processing performed by the input processor on each type of information will now be described in detail.

With reference to image type information (e.g., see, step 101A), when processing image information such as, for example, an image file, the input processor would use an image processor (e.g., in step 102) which would determine how colorful the image is and/or how the luminance of the image changes over the entirety of the image. For example, the colorfulness of an image can be determined by taking a number of samples of the image at various locations and determining how many different colors are present. These various locations can be determined randomly (e.g., using a random number generator), can be determined based upon the size and/or shape of the image, and/or can be predetermined (e.g., at x-, y-, and/or z-axis locations). Further, luminance changes over an image can optionally be determined by sampling in, for example, a spiral pattern from the center of the image outwards. At each sample position, an average luminance value over a square patch (e.g., a few pixels wide) can be determined. The spiral can be scaled such that an equal number of samples are taken for each image independent of size. However, it is also envisioned that the location and/or number of samples can be randomly determined or determined based upon other considerations (e.g., size, color, luminance, etc.), as desired. In yet other embodiments, it is envisioned that digital image processing (DSP) may be performed on images to determine various features of these images. For example, a facial recognition step may be performed to determine whether different images of a person are of the same person. If it is determined in the facial recognition step that the person is the same person, similar outputs may be output by the system regardless of other inputs. Similarly, the system according to the present invention can optionally determine an image's background and output information accordingly. Thus, for example, if it is determined that the same person is in two different input images, background information such as, for example, snow (indicative of winter), flowers (indicative of spring), green leaves (indicative of summer), and/or brown leaves (indicative of autumn), can be optionally used to determine an appropriate output.

With reference to sound information (e.g., see, step 101B), when processing sound information such as, for example, a sound file, the input processor (e.g., in step 102) can merge optional left and right stereo signals into a mono stream, if desired. Additionally, any sound information which is determined to be below a certain threshold (e.g., a silent area at the beginning of a sound file), can be optionally skipped to avoid non-relevant data input and processing, as desired. The sound information can then be split into a number of overlapping segments and series of filters can be applied to each segment (in series or optionally in parallel) to determine how strongly the sound was represented in a number of different frequency bands. The resultant data is a stream of information that describes how active the sound is in each frequency band over time. As discussed above, a suitable method to determine frequencies contained in the input sound information can optionally include performing anFFT on the input sound information to determine frequencies contained within the input sound information. The results of the Fourier analysis are then processed so that they correspond to scale such as, for example, the Bark scale.

With reference to rhythm information (e.g., see, step 101D), although the rhythm information can be encoded as a sound file, a type of information that is of interest is the pulsations of the rhythm (as opposed to the frequency of the sound waves of the rhythm itself). Thus, when it is determined that a rhythm is being input, the input processor (e.g., in step 102) uses a beat detection algorithm to determine the start and end of each beat and to produce a stream of floating point numbers which indicates the variation of the corresponding time between the beats. However, it is also envisioned that the input processor can determine the frequencies contained in the sound file as well, if desired.

The creation of music “structure” or “pattern” will now be explained with reference to step 104. In this step, a composition process occurs in two stages (although a single or other number of stages is also envisioned). The first stage establishes a basic structure of the music in terms of basic operations and then the basic structure of the music is converted (e.g., using custom software, etc.) into notes which are used in a final composition. Step 104 outputs data such as, for example, an XML file that describes a final piece of music (e.g., in terms of musical processes rather than, for example, musical notes).

The creation of music structure is performed using a conventional interference engine (i.e., a composition “engine,” not shown) such as, for example, a CLIPS (C Language Integrated Production System)-type interference engine which processes the streams of input information (e.g., floating point numbers in the range of, for example, 0.0 to 1.0 received from the step 102) and generates a corresponding musical structure. Each time a decision is required, a value is taken from an input stream and used to select among the available possibilities. If, for example, the input stream is exhausted before the composition process is finished, then the software can cycle around to the beginning of the input stream and/or re-use a previous value until the composition process is complete. However, rather than reusing previous values, other values can also be used, as desired. Tables relating to facts will be described below with reference to Tables 12-15.

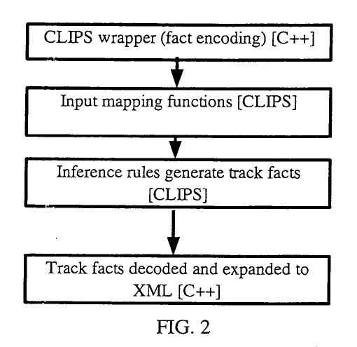

Referring to FIGS. 1A and 2, a wrapper process encodes (e.g., using software written in, for example, C++ or other suitable language and/or hardware which can perform a similar function) the input streams as “facts”(wherein, the facts represent an item of knowledge such as, for example, a value of an input element No. 3 (where 3 is arbitrarily selected and has no special significance) which can be 0.45) in the CLIPS inference engine which transforms the floating point numbers received from step 102 to a suitable format such as, for example, an XML format as will be described below. The interference engine (e.g., the CLIPS engine) is capable of processing and generating the facts. Each fact can be a set of values which can optionally have names associated with them. However, facts can be generated as data without an associated name and can be considered to be equivalent to data structures in other programming languages. Mapper functions (of which there are currently 61—however other numbers are also envisioned) written in, for example, a scripting language corresponding with the inference engine, allows the input used by each decision point to be taken from a particular input stream (e.g., output from step 102) and processed in a way appropriate to that decision point. This allows the system to change which parts of the input stream affect which part of the composition process without having to change the composition engine itself. Decision points are places in the software where a specific feature of the output music is determined. For example, decision points may correspond to a rhythm template, music tonality (e.g., C minor pentatonic) to use for a certain track at a given part of the tune, a music instrument to use for a certain track, and a base note length for a particular track. The decision points are part of the software and set by the programmer. For example decision points may be implemented by a call to a function such as an inputX function which can include functions such as, for example, an inputIntegerPickLDC(?min ?max) function which selects a next value from a particular input stream and determines minimal and maximal values of the stream. By changing, for example, the inputIntegerPickLDC function, a different input stream for a particular decision point can be used without having to change the music composition process. For example, an entirely new input stream resulting from, for example, processing text could be added by changing one or more of the inputX function(s) so as to select the new input stream. Thus, for example, if it is desired that a new input stream of numbers (e.g., in addition to the ones generated from the images, sounds, voice sample and rhythms) such as, for example, an input stream generated by processing a passage of text be added, then all that would be required to make use of this new input stream in the composition process would be to change some of the inputX functions to pick values from the new stream rather than one of the existing ones. Accordingly, the system according to the present invention can be easily scaled to introduce new input streams.

With reference to the composition process of step 104, there are several optional operations (e.g., I-VIII) which can be performed, as desired, during this composition process. The first operation (i.e., step I) and last three (i.e., steps VI-VIII) are global and preferably operate on all tracks, and the others (i.e., steps II-V) preferably operate on a per-track basis, as desired. However, one or more of these operations or variations thereof can be performed on any selected track, if desired. These operations are better illustrated with reference to Table 1 below.

TABLE 1
OPERATIONS

| | |
|---|---|
| I. | Creation of global parameters. This can include selecting the overall tempo, a total |
| | number of tracks to create, which instruments may be used to generate the music, scales |
| | which may be used in the music, and a number of harmonic mathematic (see Harmonic |
| | Maths below) parameters and how the number of playing tracks will vary over the length |
| | of the music (i.e., a “zone profile”). |
| II. | Assigning instruments to tracks. In the present example, there are 3 stages to this |
| | (however, other number stages are also envisioned as being possible): |
| 1. | Stage 1. Obligatory instruments. The system may be configured such that |
| | each piece of music can have a certain number of tracks played by optionally |
| | selected instruments chosen from, for example, a set of instruments. For |
| | example, in one embodiment, at least a certain type of instrument (e.g., a piano) |
| | is used in every generated piece of music. |
| 2. | Stage 2. Non-obligatory instruments. Other instruments for the remaining |
| | tracks outside the set of obligatory instruments can be optionally selected. To |
| | ensure variety, certain instruments (e.g., other than those which were previously |
| | selected), can be selected. |
| 3. | Stage 3. Additional instruments. Each piece of music can be defined to have |
| | zero or more (up to a predefined maximum) tracks of “additional instruments.” |
| | Previously selected instruments selected from the instruments which have not |
| | yet been selected can be used. |
| | By controlling the limits (e.g., the maximum number of tracks) for each stage of the |
| | instrument process, control over the instrument selection process can be maintained while |
| | allowing variety. |
| III. | Selecting the “tonality order” prior to selecting an actual sequence of tonalities to be used |
| | by a track, a number of notes in the tonality can be selected. For example, it is selected |
| | whether a track will use 7-note, 5-note (pentatonic) or 3-note scales. However, it is |
| | optionally envisioned that the global parameters decided in the first phase will cause all |
| | tracks to use the same scale order, in which case this phase does not have any effect and |
| | may not have to be performed. |
| IV. | Choosing the rhythm - in this phase, the note length used in a track can optionally be |
| | selected as well as the rhythm template, the duration of a cycle (how long before the |
| | rhythm repeats) and how note length and volume will vary according to harmonic maths |
| | processes (which is described below). Although most tracks will include patterns with |
| | the same note lengths, the system may also produce syncopated rhythms with notes of |
| | varying lengths and notes occurring off the beat - this is done by selecting from an |
| | optional set of syncopated rhythm templates rather than the standard rhythm templates. |
| | Please note, as used herein, a rhythm template does not specify the actual length of notes |
| | but rather the relative lengths of notes and rests. This means a single template. For |
| | example, a template might be (1 0 0.5 0.5 1 0) if the base note length chosen for the track |
| | was 480 MIDI ticks then the actual note lengths used in the rhythm would be (480 0 240 |
| | 240 480 0). |
| V. | Choosing the final tonality. The actual sequence of tonalities to use for a track can |
| | optionally be selected from the set available for the tune. The actual set of tonalities |
| | available for a tune can depend on, for example, the global parameters set in the first |
| | stage. This stage can optionally set a register (e.g., the octave in which the instrument is |
| | playing in) the track will play in and mixing parameters that control the volume of the |
| | track relative to the others. |
| VI. | Part switching. Optionally, fewer than all of the tracks play all the time. Variety can |
| | then be added by changing the set of playing tracks throughout the duration of the music. |
| | See the “part switching” sub-section below for a more detailed explanation. |
| VII. | Instrument register separation. Tracks with the same instrument in the same register |
| | range can optionally be identified and be separated by moving the register for an |
| | instrument up or down depending upon whether the instrument has sufficient range. For |
| | example, if two piano pieces were playing a melody starting with c5 (the note C in the 5^{th} |
| | octave) then the system can move one of the pieces to start at octave 4 (c4). |
| VIII. | Track panning. Instruments such as, for example, bass and/or drums can be placed in |
| | the center of the stereo range and the remaining tracks are spread to cover the range from |
| | left to right channels. In order to ensure that a tune is not “lop-sided” (where, for |
| | example, most playing tracks are on one of the left or right channels), tracks with the |
| | highest play counts are selected first and a tracks can be distributed between left and right |
| | channels in order of descending play count. |

With reference to step VI above, part switching will now be explained in further detail. According to the part switching method of the present invention, the music may be broken up into a number of “zones” (each having an index z) and transitions such as, for example, changing a set of playing tracks, is performed at a start of a new zone. In the present example, the zones will be given corresponding indexes z, such as, for example, 0, 1, 2, . . . Z, where Z=10. However, other numbers are possible. Each of the zones represents a “slice” of the music taken along the time access (i.e., in the time domain). For example, zone 1 is the first 30 seconds, zone 2 the second 30 seconds, etc. Each instrument is assigned a weight range (e.g., from 0.4 to 0.9 from, for example, a weight range which is between 0.0 and 1.0) when, for example, an instrument is selected for a track. Then the instrument's weight range is assigned to the corresponding track. The correspondingly assigned weights are used to determine how often the track may play. Thus, for example, a track with a weight of 0.0 would never play while a track with a weight of 1.0 would play all the time. However, other ranges and settings are also envisioned.

With reference to step I above, the “zone profile” selected in the first phase (i.e., step I) of a tune controls how many tracks can play in each zone. For example, in each zone, the zone profile includes a number in the range 0.0 to 1.0 (although other ranges are also envisioned, as desired). The configuration for a particular genre (e.g., see, “beat” method below) specifies a minimum number of tracks that can play at any one time. According to the present example, a zero in the zone profile controls such that a minimum number of tracks play, whereas a one controls such that all available tracks can play. The actual effect of the zone profile can be optionally modulated by values included within and taken (e.g., by the system) from the input stream.

In order to allow for more variety, optional configuration options (e.g., values) can be used to control the effect of the zone profile described above. For example, a zoneValueWeight value can be optionally assigned to the zone profile to control how much influence the zone profile exerts over the final result. Further, a zoneInputWeight value can be optionally assigned to a value from the input stream for a given zone. The zone input weight and the zone value weight can be used to determine which has more influence on determining whether a track plays in a given zone (i.e., time segment) thereby providing for more variation. Moreover, combinations of these weights can be optionally used to decide whether the number of playing tracks should be entirely defined by the zone profile, entirely defined by the input stream, or a combination thereof. Therefore, a number of “shapes” for the tune can be defined (e.g., by gradually increasing the number of tracks until most tracks are playing and then decreasing the number of tracks at the end of the tune) and variation between tunes using the same zone profile can also be provided.

According to the present invention, for each zone a number of tracks to play can be determined according to Equations (1) and (2) below.

$$\begin{matrix} {choice}_{z} = \frac{\begin{matrix}( zoneValue * zoneValueWeight ) + \\ ( inputValue * zoneInputWeight )\end{matrix}}{( zoneValueWeight + zoneInputWeight )} ; and & Eq . ( 1 ) \\ Num \text{-} tracks \text{-} for \text{-} {zone}_{z} = min \text{-} playing \text{-} tracks + choice * ( num \text{-} tracks - min \text{-} playing \text{-} tracks ) & Eq . ( 2 )\end{matrix}$$

After determining the value of num-tracks-for-zone_{z}, this value can be optionally clipped to ensure that it lies in the range of min-playing-tracks and num-tracks. In Equations (1) and (2) above, the zoneValue is the value of the zone profile for that zone; the inputValue is the value selected from the input stream for that zone; the num-tracks is the total number of tracks defined for the corresponding tune; and the min-playing-tracks is the minimum number of tracks that is to be played at any one time. As defined below, for each of 0-T tracks, an index t can be optionally assigned.

Using Equations (1) and (2), the method and system of the present invention computes the actual tracks to play over the length of the tune according to the algorithm illustrated in Table 2 below.

TABLE 2
TRACK COMPUTATION

```
For all tracks:
    Set track play count to zero
For each zone z:
    For each track t:
        Get value from input stream, input_{tz}
        track-weight_{z} = input_{tz} * trackweightₜ
    Find the num-tracks-for-zone_{z} tracks with the highest
    values of track-weight_{z}, and:
        mark them as playing in that zone, and
        increment the track's play count
For all tracks where play count is zero:
    Get input value (e.g., value of inputXXX function for
decision point) from input stream
    Choose zone by multiplying num-zones by input value
    Set track to play in that zone
```

Referring back to FIG. 1A, after completing step 104, step 106, i.e., a music generation step, is performed. This stage takes the XML file generated by the preceding stage and produces a file having a standard protocol such as a MIDI (Musical Instrument Digital Interface) file. According to MIDI protocols, the MIDI data contains digital data “event messages” such as the pitch and intensity of musical notes to play (as opposed to an audio signal or media), control signals for parameters such as volume, vibrato and panning, cues and clock signals to set the tempo.

The process can optionally map instrument names to MIDI bank and patch numbers, and can optionally set volume and pan of MIDI tracks according to the tracks defined in the tune structure. Accordingly, the selection of the overall track (as opposed to note) volume and pan (e.g., position in stereo space) is simplified and the system can map an instrument name to MIDI instrument bank and patch numbers.

However, other parts of the process may be more complex and optionally require, for example, the generation of streams of MIDI note messages (one stream per track—where a MIDI note message is a note) from a harmonic maths process (as will be explained below) defined in the XML file received from the preceding stage (e.g., see, step 104, FIG. 1A). According to the process, a sequence of note values can be determined and then played in a loop and the process periodically modifies pitch (e.g., see, harmonic math process for modifying pitch) such that there is a harmonic relationship between a rate of variation of the pitches. For example, if one pitch changes at a rate of one step per loop, another might change at a rate of 2, another at 4, etc., as desired. This process can also be applied to note volumes and lengths. Accordingly, for a single note stream, for example, up to three quantities can vary in a harmonic relationship with each iteration of the loop. These quantities can optionally include: (1) note pitch; (2) note volume (e.g., MIDI velocity); and (3) note length. An example of an output from a harmonic maths process defined by parameters of Table 3A is illustrated in Table 3B, below.

After completing the MIDI file in step 106, the process continues to step 108.

In step 108, an audio file is generated. In this step, the MIDI file generated in step 106 is transmitted to a software synthesizer configured with sets of instruments for producing output information according to the input received. This output information can include a software sequence such as, for example, an audio file in a WAV (waveform audio format) or other format that can then be output to an encoder such as, for example, an MP3 encoder, to produce the final audio file in step 110.

In order to create a system which can produce audio information corresponding to popular music, the system can produce tracks from fragments of, for example, pre-recorded rhythms as well as harmonic maths-produced note streams, if desired. Additionally, different composition engines may be used by the system to produce music in a number of different genres based upon which of the different composition engines is used for the production. Further, genres may be represented by corresponding spreadsheets describing the various parameters used for the corresponding genre and a set of MIDI files encoding rhythm “layers” for: (1) kick (bass) and snare drums; (2) “ghost” (e.g., off the beat) kick and snare; (3) hi-hat; and/or (4) other percussion (e.g., instruments other than kick (bass) drum, snare drum, and hi-hat). However, other MIDI files encoding other rhythm layers is also envisioned.

To form a complete rhythm track, the system can combine different rhythms for each of these four rhythm layers, allowing a more authentic rhythm track than can be produced using harmonic maths alone. However, although the individual fragments are pre-recorded, the potential number of ways in which they can be combined is large, so that variety is not significantly sacrificed by using this approach. Further, the present technique may also be extended to produce tracks for other instruments crucial to a genre (e.g., a bass guitar, etc.).

A flow chart illustrating a musical structure process according to the present invention is shown in FIG. 2. In step 202, a CLIPS wrapper (fact encoding) takes the input data streams and encodes them as CLIPS facts that can be processed by the inference engine (e.g., the CLIPS-type interference engine).

In step 204, the input mapping functions are called at each decision point to pick a value from an input stream to pick a particular feature of the output music.

In step 206, inference rules generate track facts (CLIPS) which contain all the information required to generate a complete track of the output music.

In step 208, track facts are decoded and a complete specification of the composed music is generated in XML format.

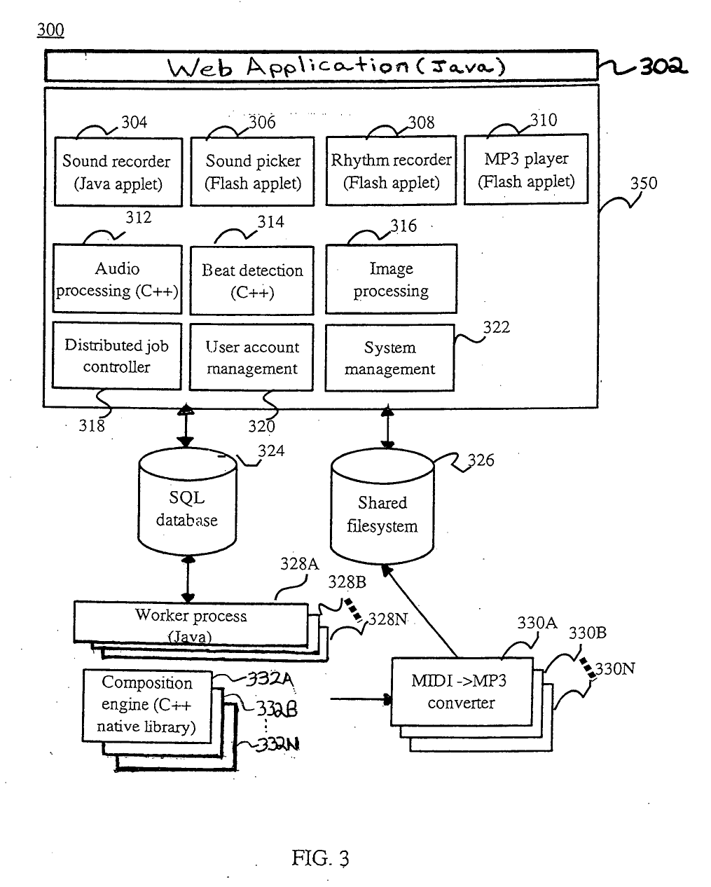

A block diagram of an embodiment of the system according to the present invention for interfacing with a network such as the Internet is shown in FIG. 3. A system 300 can include one or more functional blocks such as, for example, a web interface (e.g., a web server) 350, one or more worker processes 328A-328N, one or more operative programs such as, for example, external programs 330A-330N, a database such as, for example, an SQL database 324, and a shared memory (or other memory) such as, for example, a shared file system 326. Although not shown, each of these functional blocks can include a processor, a memory (e.g., a RAM, ROM, flash memory, disc drive, etc.), an interface (e.g., an input/output interface), and/or software to control, as desired. Further, each of the functional blocks can communicate with the other functional blocks directly or via a network (e.g., via wired or wireless connections). Moreover, one or more of the functional blocks can be incorporated within one or more of the other functional blocks, as desired. For example, a functional block can be operative in a user's computer and communicate with another functional block via, for example, a wireless Internet connection. Data generated (e.g., by the system) can then be stored on yet another device in communication with the user via, for example, a wireless network connection.

The web interface 350 provides an interface for one or more users to interact with software and/or provides processing required to translate user input into a form which can be used by the one or more composition engines 332A-332N. A more detailed description of the web interface 350 will be given below.

The one or more worker processes 328A-328N provide computation means for computational-intensive tasks such as, for example, composing the music and/or converting the note data to an audio file having a desired format (e.g., MP3, AAC, WAV, FLAC, CD (compact disc), etc.). The worker processes 328A-328N can receive job requests generated by the Web interface via, for example, the SQL database 324 and can thereafter process the received job requests in, for example, series and/or in parallel, if desired. Accordingly, the greater the number of worker processes running (e.g., one or two per processor core) at the same time (i.e., in parallel), the more work the system can perform during this time. The worker processes are written in, for example, Java and can use a native library to communicate with the C++ software (described above) that is used to compose the music.

The one or more external programs 330A-330N are called by the worker processes 328A-328N to convert the MIDI note data to audio information. The external programs 330A-330N can include one or more UNIX shell scripts each of which can invoke a number of command-line programs (not shown) to perform the conversion of the MIDI note data to audio information.

The SQL database 324 can store all user input data as well as user account information and/or other data required for the web interface to function. In other embodiments, other databases (e.g., local or remote) can be used. Additionally, the databases can use any suitable memory means such as, for example, flash memory, one or more hard discs, etc.

The shared file system 326 can include storage means for storing large data objects such as MP3 audio files which are generated by the system. Each of the functional blocks of the system 300 can read and/or write and/or otherwise access the shared file system 326. For example, MP3 files and other data can be stored in the shared file system 326, and the web interface 350 can access, read, and/or transmit the stored data to other devices over a network such as, for example, the Internet.

The web interface 350 can include components that enables users and/or the system to create accounts, compose pieces of music, and/or access previously composed music. The web interface 350 can include modules to create job requests for processing by the worker processes 350, and/or web interface 350 for staff members and/or the system to manage the system and/or to monitor performance of the system. The major sub-components of the web interface include one or more of: a sound recorder (e.g., a Java applet) 304; a sound picker (e.g., a flash applet) 306; a rhythm recorder (e.g., a flash applet) 308; an MP3 player (e.g., a flash applet) 310; an audio processor (e.g., performed by the C++ software described above) 312; a beat detector (performed by the C++ software described above) 314; an image processor 316; a distributed job controller 318; a user account manager 320; and a system manager 322.

Although only a single web server 350 (e.g., a front end web interface) is illustrated, the system may also include a plurality of web servers 350 that run the web interface. Accordingly, load balancing means such as, for example, load balancing software and/or hardware may be used to balance loads between the plurality of servers 350. Further, although not shown, the server 350 can include one or more of the one or more worker processes 328A-328N, the one or more operative programs such as, for example, external programs 330A-330N, and/or the one or more composition engines 332A-332N, if desired.

The sound recorder 304 can include software and/or hardware for users to record audio directly (e.g., on a user's PC, a stand-alone kiosk, etc.) and/or via a network such as, for example, by using the web (e.g., via the Internet). In the preferred embodiment, the sound recorder includes a Java applet that allows users to record audio using the web without having corresponding recording software installed on their computer. The audio data is sent from the applet to the web server 350 using, for example, an HTTP (hypertext transfer protocol).

The sound picker 306 can record one or more sounds or other audio information (e.g., from a database) for selection (e.g., by a user). One or more of the selected sounds can then be input into the system (e.g., see, steps 100 and 102 in FIG. 1A). A maximum number of sounds can be optionally set such that, for example, the user cannot select more than the maximum number of sounds. The method (e.g., using the sound picker 306 to select predetermined information) can optionally be used as an alternative to recording new audio via the sound recorder 304.

The rhythm recorder 308 provides can record a rhythm via inputs from an input device such as, for example, for example, a mouse input (e.g., via an input button), a tracking device (e.g., a digitizer pen, a track ball, a finger pad, a track pen, etc.), a keyboard input, a screen input, etc. Additionally, the rhythm record can record a rhythm corresponding to an input from the input device. For example, if using the microphone, sounds indicative of a user clapping or hitting something can be recorded to form a rhythm. Likewise, a user can click a mouse input key to form a rhythm which corresponds to the clicks. Further, a user can tap a digitizer pen on a surface to form a rhythm which corresponds with the taps. The user's input can then be transmitted to the rhythm recorder.

The MP3 player 310 provides means for a user to play back audio files such as, for example, MP3 files. Accordingly, the MP3 player can include a flash MP3 player (soft or hard) button which, for example, when selected, plays MP3 files directly in, for example, a Web page accessed by the user. As such players are common in the art, for the sake of clarity, a further description thereof will not be given.

The audio processor 312 may include a collection of Java and/or C++ classes that can process sound files to generate statistical data for input into, for example, the composition process as described above with respect to the input processing process (e.g., see, step 102, FIG. 1, etc.).

The image processor 316 can process image files and optionally generate statistical information for input into, for example, the composition process as described above with respect to the input processing process (e.g., see, step 102, FIG. 1, etc.). The image processor 316 can include a collection of Java classes that process image files to generate the statistical information. However, other means, such as, for example, hardware are also envisioned.

The beat detector 314 performs simple beat detection on a selected audio file and outputs statistical data as described above with respect to the input processing process (e.g., see, step 102, FIG. 1, etc.). The beat detector 314 can include, for example, software such as Java and C++ classes for performing the beat detection process on a selected audio file.

The distributed job controller 318 manages the creation and processing of job requests which will be processed by worker processes (i.e., 328A-328N, 330A-330N, and/or 332A-332N). The distributed job controller 318 can include, for example, Java classes to manage the creation and processing of the job requests which will be processed by the worker processes.

User account manager 320 provides a web interface for a user to manage his account. Accordingly, the user account manager 320 can include software such as, for example, Java classes which may be used to provide a web interface for providing the user means to manage the user's accounts. Additionally, the user account manager 320 can include software such as, for example, supporting classes which provide functionality to implement user management.

System manager 322 provides a management interface which can be used by, for example, operators (e.g., staff members, etc.) of the system, such that the operators may monitor the system of the present invention. Accordingly, the system manager can include, for example, Java classes to provide the management interface for the operators to monitor the system.

A brief overview of the harmonic maths process (e.g., see, Lawrence Ball, “Harmonic Mathematics, Basic theory & application to audio signals,” May 1999) which is incorporated herein by reference), as used by the present invention to generate music will now be given with reference to Tables 3 and 4 below.

A description of a moving value in a wavetable used by the system of the present invention will now be provided. The values that are adjusted can be, for example: (1) a MIDI note pitch in the range of, for example, 0-127 (or other suitable ranges). Further, adjustments can be optionally made so that the MIDI note pitch can be restricted to values within the current tonality; (2) a MIDI note volume in the range of, for example, 0-127; and (3) a floating point scaling value used to adjust the note length of a MIDI note. An example of a harmonic maths process and the output generated (e.g., see, Table 4) for the parameters listed in Table 3A is shown below with reference to Table 3B.

TABLE 3A

| ITEM (PARAMETER) | VALUE |
|---|---|
| start fraction (a start value in the sequence) | 0 |
| end fraction (an end value in the sequence) | 0.3 |
| Resolution (amount of change in accumulator to trigger | 192 |
| one unit of change in the output) | |
| Number of loop iterations | 20 |
| mod vector (this is what is added into the accumulator | 24, 48, 72, 96, |
| to cause the change so there is a harmonic relationship | 72, 48, 24 |
| between the elements of this vector) | |
| input sequence (these are the valid output values - the | 1, 2, 3, 4, 5, 6, |
| harmonic maths process controls the index into this | 7, 8, 9, 10 |
| array; by making the sequence the interval pattern for | |
| a musical scale it can be ensured that the output of the | |
| process generates notes only in the correct scale) | |
| Block length (how many elements in the loop) | 7 |
| Max (max accumulator value) | 1729 |

TABLE 3B
HARMONIC MATHS OUTPUT

| Iteration | Accumulator | Position in sequence | Output |
|---|---|---|---|
| 0 | 24, 48, 72, 96, 72, 48, 24 | 0, 0, 0, 0, 0, 0, 0 | 1, 1, 1, 1, 1, 1, 1 |
| 1 | 48, 96, 144, 192, 144, 96, 48 | 0, 0, 0, 1, 0, 0, 0 | 1, 1, 1, 2, 1, 1, 1 |
| 2 | 72, 144, 216, 288, 216, 144, 72 | 0, 0, 1, 1, 1, 0, 0 | 1, 1, 2, 2, 2, 1, 1 |
| 3 | 96, 192, 288, 384, 288, 192, 96 | 0, 1, 1, 2, 1, 1, 0 | 1, 2, 2, 3, 2, 2, 1 |
| 4 | 120, 240, 360, 480, 360, 240, 120 | 0, 1, 1, 2, 1, 1, 0 | 1, 2, 2, 3, 2, 2, 1 |
| 5 | 144, 288, 432, 576, 432, 288, 144 | 0, 1, 2, 3, 2, 1, 0 | 1, 2, 3, 4, 3, 2, 1 |
| 6 | 168, 336, 504, 672, 504, 336, 168 | 0, 1, 2, 3, 2, 1, 0 | 1, 2, 3, 4, 3, 2, 1 |
| 7 | 192, 384, 576, 768, 576, 384, 192 | 1, 2, 3, 4, 3, 2, 1 | 2, 3, 4, 5, 4, 3, 2 |
| 8 | 216, 432, 648, 864, 648, 432, 216 | 1, 2, 3, 4, 3, 2, 1 | 2, 3, 4, 5, 4, 3, 2 |
| 9 | 240, 480, 720, 960, 720, 480, 240 | 1, 2, 3, 5, 3, 2, 1 | 2, 3, 4, 6, 4, 3, 2 |
| 10 | 264, 528, 792, 1056, 792, 528, 264 | 1, 2, 4, 5, 4, 2, 1 | 2, 3, 5, 6, 5, 3, 2 |
| 11 | 288, 576, 864, 1152, 864, 576, 288 | 1, 3, 4, 6, 4, 3, 1 | 2, 4, 5, 7, 5, 4, 2 |
| 12 | 312, 624, 936, 1248, 936, 624, 312 | 1, 3, 4, 6, 4, 3, 1 | 2, 4, 5, 7, 5, 4, 2 |
| 13 | 336, 672, 1008, 1344, 1008, 672, 336 | 1, 3, 5, 7, 5, 3, 1 | 2, 4, 6, 8, 6, 4, 2 |
| 14 | 360, 720, 1080, 1440, 1080, 720, 360 | 1, 3, 5, 7, 5, 3, 1 | 2, 4, 6, 8, 6, 4, 2 |
| 15 | 384, 768, 1152, 1536, 1152, 768, 384 | 2, 4, 6, 8, 6, 4, 2 | 3, 5, 7, 9, 7, 5, 3 |
| 16 | 408, 816, 1224, 1632, 1224, 816, 408 | 2, 4, 6, 8, 6, 4, 2 | 3, 5, 7, 9, 7, 5, 3 |
| 17 | 432, 864, 1296, 1728, 1296, 864, 432 | 2, 4, 6, 9, 6, 4, 2 | 3, 5, 7, 10, 7, 5, 3 |
| 18 | 456, 912, 1368, 95, 1368, 912, 456 | 2, 4, 7, 0, 7, 4, 2 | 3, 5, 8, 1, 8, 5, 3 |
| 19 | 480, 960, 1440, 191, 1440, 960, 480 | 2, 5, 7, 0, 7, 5, 2 | 3, 6, 8, 1, 8, 6, 3 |

As described in Tables 3A and 3B, an accumulator is a vector having a length wherein each element of the accumulator is initialized to zero. At each step (i.e., iteration) t, the contents of a mod_vector having the same length as the accumulator vector (e.g., see, Table 5) is added to the accumulator vector. The result modulus, a maximum value is stored back in the accumulator. The elements of the mod_vector are related by a geometric relationship. For example, if element 1 of the mod_vector is 24, then element 2 would be 48, element 3 would be 72 . . . . Thus, the elements of the accumulator will change at different rates that have a fixed relation to one another (e.g., element 2 changes at twice the rate of element 1). Each time an element of the accumulator passes a multiple of the resolution, the value of the output of the system at that position changes. Typically, the output is used to index into a sequence which represents some useful quantity such as, for example, a series of musical pitches. Accordingly, the harmonic maths process can generate musical pitches, as shown in the sample run of Table 4 above. According to the present application, if a[] is the accumaltor and m[] the mod_vector then at each iteration, for every element k of a and m the following operation as defined in Equation (3) is performed:

a[k]=(a[k]+m[k]) % max Eq. (3)

In Equation (3), % is the modulus operator and max is the maximum value.

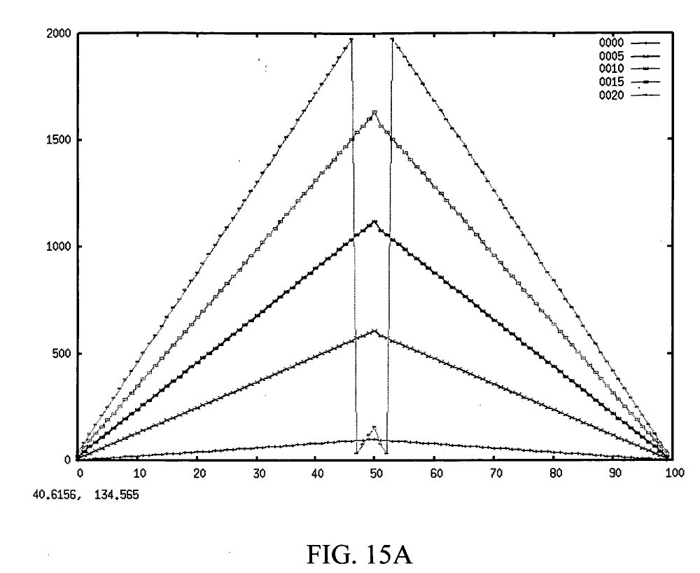

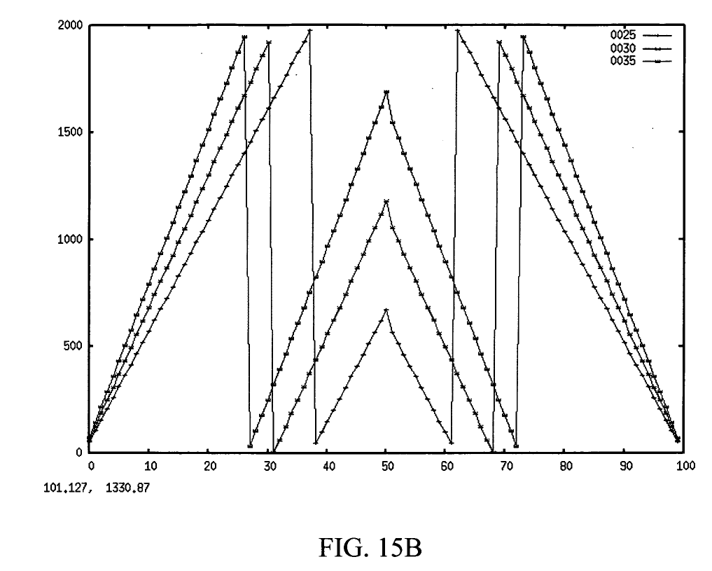

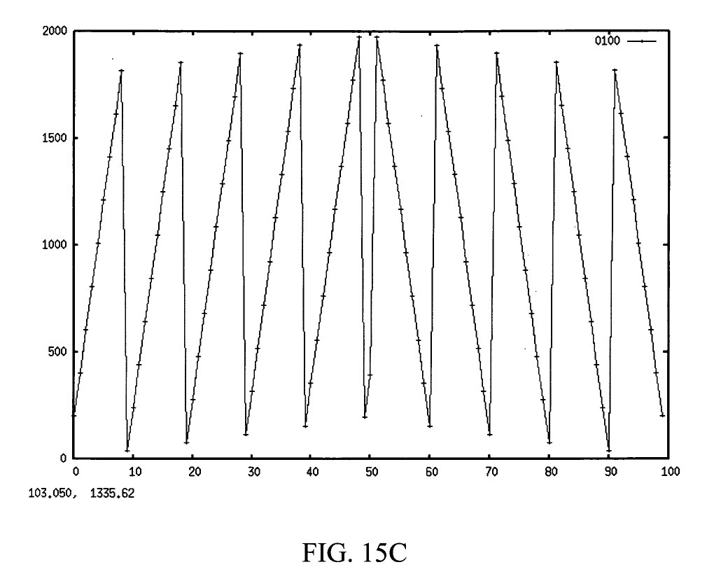

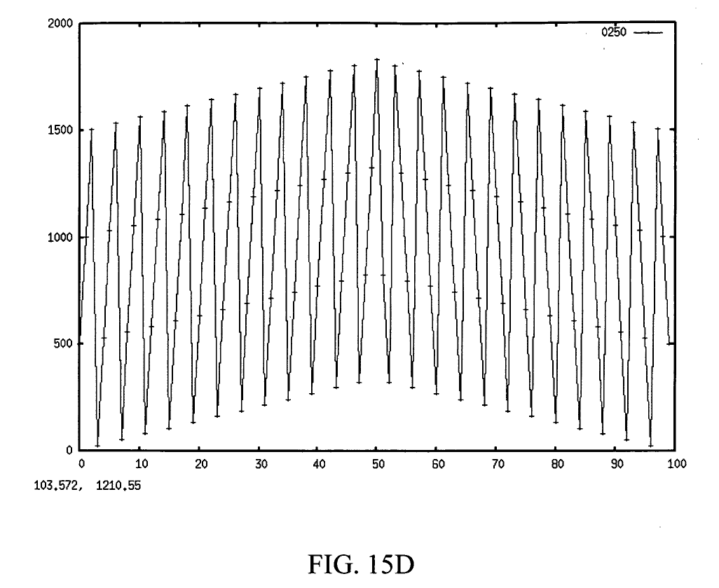

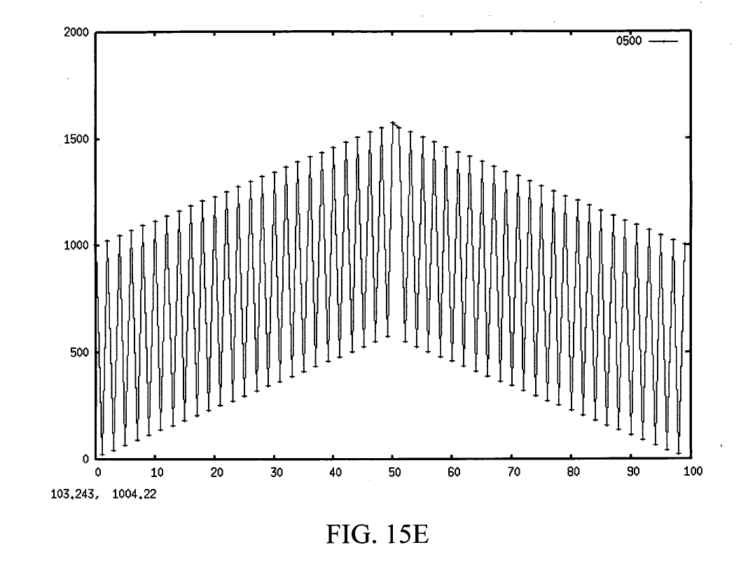

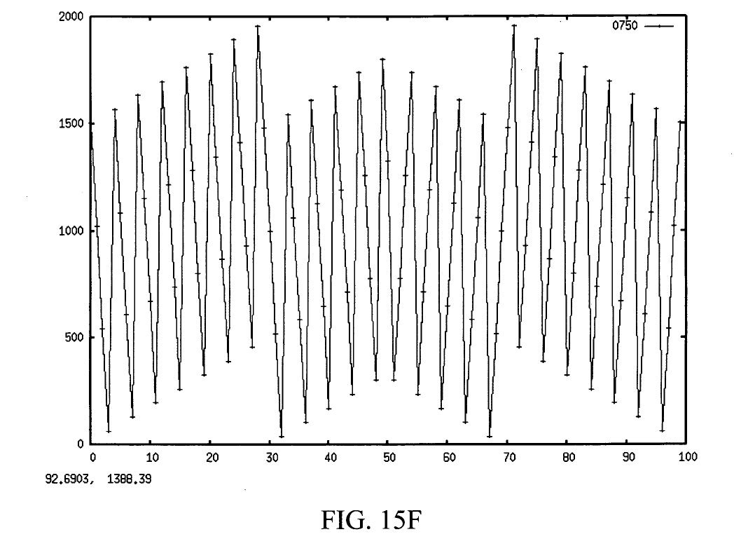

The system of the present invention uses a mathematical technique known as the “forms of the math” to create computer graphics videos, musical scores, recordings, and in some cases audio-visual videos with mathematical correspondence of the two media. This technique provides a method for controlling a one or more dimensional array of parameters over time (e.g., see, Lawrence Ball, Id.; and John Whitney, “Digital Harmony: On the Complementarity of Music and Visual Art” McGraw Hill 1981). Graphs illustrating the output of a harmonics maths process according to the present invention are shown in FIGS. 15A-15F. These graphs correspond with the output of a harmonics maths process which has which is shown in Table 4 below and uses 100 elements (i.e., points) and continues for 1000 iterations.

TABLE 4

start fraction, 0
end fraction, 1
resolution, 8
numIterations, 1000
mod vector, 2, 4, 6, 8, 10, 12, 14, 16, 18, 20, 22, 24, 26, 28,
30, 32, 34, 36, 38, 40, 42, 44, 46, 48, 50, 52, 54, 56, 58, 60,
62, 64, 66, 68, 70, 72, 74, 76, 78, 80, 82, 84, 86, 88, 90, 92,
94, 96, 98, 100, 102, 98, 96, 94, 92, 90, 88, 86, 84, 82, 80, 78,
76, 74, 72, 70, 68, 66, 64, 62, 60, 58, 56, 54, 52, 50, 48, 46,
44, 42, 40, 38, 36, 34, 32, 30, 28, 26, 24, 22, 20, 18, 16, 14,
12, 10, 8, 6, 4, 2
input sequence, 1, 2, 3, 4, 5, 6, 7, 8, 9, 10, 11, 12, 13, 14, 15,
16, 17, 18, 19, 20, 21, 22, 23, 24, 25, 26, 27, 28, 29, 30, 31,
32, 33, 34, 35, 36, 37, 38, 39, 40, 41, 42, 43, 44, 45, 46, 47,
48, 49, 50, 51, 52, 53, 54, 55, 56, 57, 58, 59, 60, 61, 62, 63,
64, 65, 66, 67, 68, 69, 70, 71, 72, 73, 74, 75, 76, 77, 78, 79,
80, 81, 82, 83, 84, 85, 86, 87, 88, 89, 90, 91, 92, 93, 94, 95,
96, 97, 98, 99, 100
blockLength, 100
resolutionThisTime, 20
max, 1981

With reference to FIGS. 15A-15F, the graph illustrated in FIG. 15A shows an output of the process at 0, 5, 10, 15, and 20 iterations. The graph illustrated in FIG. 15B shows an output of the process at 25, 30, and 35 iterations. Note, at 25 iterations some of the elements have already passed the maximum value and wrapped around. The graph illustrated in FIG. 15C shows the process after 100 iterations. As shown, after 100 iterations some of the elements have wrapped around several times and many peaks have formed. The graph illustrated in FIG. 15D shows an output of the process after 250 iterations. There are now 25 peaks. The graph illustrated in FIG. 15E shows an output of the process at 500 iterations. Lastly, the graph illustrated in FIG. 15F shows an output of the process at 750 iterations.

An example of the XML format used to encode the tune structure is illustrated in Table 4 below. For the sake of clarity, most of the track definitions have been removed and only a few examples of a preset-driven track and harmonic-maths-driven tracks remain. In addition, the normal XML files used by the method of the present invention may contain a copy of the input streams upon which they are based. However, for the sake of clarity, as the input streams include a long vector of floating point numbers, they are not shown.

TABLE 4
XML TUNE SPECIFICATION

```
<?xml version=“1.0” encoding=“UTF-8”?>
<!DOCTYPE tune SYSTEM “file:/usr/local/home/dns/projects/method-music/data/tune.dtd”>
<tune tempo=“98” clicks_per_beat=“480” >
  <timesig notenum=“4” notetype=“4” />
  <attributes>
    <attribute name=“input.config.duty.cycle025.weight” descriptor=“float” >
      0.1500000059604645
    </attribute>
    <attribute name=“input.config.duty.cycle050.weight” descriptor=“float” >
      0.1500000059604645
    </attribute>
    <attribute name=“input.config.duty.cycle100.weight” descriptor=“float” >
      0.699999988079071
    </attribute>
    <attribute name=“input.config.max.bass.instruments” descriptor=“long” >
      1
    </attribute>
    <attribute name=“input.config.min.obligatory.instruments” descriptor=“long” >
      1
    </attribute>
    <attribute name=“input.config.min.playing.tracks” descriptor=“long” >
      7
    </attribute>
    <attribute name=“input.config.name” descriptor=“string” >
      Central v3
    </attribute>
    <attribute name=“input.config.num.additional.tracks.range” descriptor=“vector:long” >
      1, 4
    </attribute>
    <attribute name=“input.config.num.instrument.range” descriptor=“vector:long” >
      5, 11
    </attribute>
    <attribute name=“input.config.obligatory.instruments” descriptor=“vector:string” >
      HHAcousticBass,HHElecBass,HHSynthBass2,HHSynthBass1
    </attribute>
    <attribute name=“input.config.tonality.orders” descriptor=“vector:long” >
      5
    </attribute>
    <attribute name=“input.instruments.enabled” descriptor=“vector:string” >
      MM Acoustic
Guitar,HHPad1,HHPad2,HHOrgan1,HHOrgan2,HHElecGtr,HHMuteGtr,HHAcousticBass,HHElecPiano1,HH
Strings3,HHLeadSynth1,HHLeadSynth2,HHPiano1,HHElecPiano2,HHPiano2,HHStrings4,HHDrums,HH
Vibraphone,HHSynthMarimba,MM Oboe,HHElecBass,HHSynthBass2,HHLeadSynth4,HHSynthBass1,MM
Solo Cello,MM Solo Violin,HHStrings1,HHStrings2
    </attribute>
    <attribute name=“output.tune.lnc-map.filter” descriptor=“string” >
      Power 2
    </attribute>
    <attribute name=“output.tune.lnc-map.type” descriptor=“string” >
      adjacent-column
    </attribute>
    <attribute name=“output.tune.loop.durations.lengths” descriptor=“vector:long” >
      240, 1, 240, 2, 960, 1, 960, 2, 960, 4, 960, 8
    </attribute>
    <attribute name=“output.tune.loop.durations.lengths.rapid” descriptor=“vector:long” >
      240, 1, 240, 2, 960, 1, 960, 2, 960, 4, 960, 8
    </attribute>
    <attribute name=“output.tune.num-zones” descriptor=“long” >
      4
    </attribute>
    <attribute name=“output.tune.overall-cycle-fraction” descriptor=“long” >
      1
    </attribute>
    <attribute name=“output.tune.perforation.level” descriptor=“float” >
      3
    </attribute>
    <attribute name=“output.tune.tonality-duration” descriptor=“long” >
      15360
    </attribute>
    <attribute name=“output.tune.tonality.mode” descriptor=“long” >
      4
    </attribute>
    <attribute name=“output.tune.zone-duration” descriptor=“long” >
      15360
    </attribute>
    <attribute name=“output.tune.zoneProfile.name” descriptor=“string” >
      4peak2
    </attribute>
    <attribute name=“output.tune.zoneProfile.shape” descriptor=“string” >
      Peak
    </attribute>
    <attribute name=“output.tune.zoneProfile.zones” descriptor=“vector:float” >
      0.3, 0.7, 1, 0.4
    </attribute>
  </attributes>
  <track midi_channel=“1” volume=“1” pan=“0” >
    <name>4</name>
    <instrument>HHSynthBass1</instrument>
    <attributes>
      <attribute name=“output.track.loop.duration” descriptor=“long” >
        240
      </attribute>
      <attribute name=“output.track.loop.length” descriptor=“long” >
        1
      </attribute>
      <attribute name=“output.track.tonality-sequence.name” descriptor=“string” >
        pentripple3
      </attribute>
      <attribute name=“output.track.zone.probability” descriptor=“float” >
        0.7716522216796875
      </attribute>
    </attributes>
    <segments>
      <map_controlled_segment silent_development=“yes” >
        <timemap>
          <enabled_time_interval enabled=“no” duration=“8/1” />
          <enabled_time_interval enabled=“no” duration=“8/1” />
          <enabled_time_interval enabled=“yes” duration=“8/1” />
          <enabled_time_interval enabled=“yes” duration=“8/1” />
        </timemap>
        <basic_note_generator velocity=“63” >
          <hmsequence resolution=“720” num_block_repeats=“4” num_total_repeats=“400”
            start_fraction=“0.25” end_fraction=“0.4000000059604645” >
            <mod_vector num_copies=“1” >
              60
            </mod_vector>
            <abstract_note_sequence num_copies=“1” >
              5, 6, 7, 8, 9, 10, 9, 8, 7, 6, 5, 4, 3, 2, 1, 0, 1, 2, 3, 4, 5
            </abstract_note_sequence>
          </hmsequence>
          <tonalities>
            <tonality name=“C5ripple01” root_note=“A2” duration=“8/1” />
            <tonality name=“C5ripple02” root_note=“A2” duration=“8/1” />
            <tonality name=“C5ripple03” root_note=“A2” duration=“8/1” />
            <tonality name=“C5ripple02” root_note=“A2” duration=“8/1” />
          </tonalities>
          <rhythm>
            <note duration=“#240” />
            <note duration=“#240” />
            <note duration=“#240” />
            <note duration=“#240” />
          </rhythm>
          <gate_times>
            <hmsequence_float resolution=“720” num_block_repeats=“4” num_total_repeats=“400”
              start_fraction=“0.3333300054073334” end_fraction=“0.6000000238418579” >
              <mod_vector num_copies=“1” >
                60
              </mod_vector>
              <percentage_sequence num_copies=“1” >
                55, 59, 63, 67, 71, 75, 79, 83, 87, 91, 95, 91, 87, 83, 79, 75, 71, 67, 63, 59, 55
              </percentage_sequence>
            </hmsequence_float>
          </gate_times>
        </basic_note_generator>
      </map_controlled_segment>
    </segments>
  </track>
  ... track definition removed for brevity ....
  <track midi_channel=“10” volume=“0.787” pan=“0” >
    <name>1</name>
    <instrument>HHDrums</instrument>
    <attributes>
      <attribute name=“output.track.preset.data.names” descriptor=“string” >
        HH_GKS_Preset07.mid,HH_GKS_Preset03.mid,HH_GKS_Preset22.mid,HH_GKS_Preset04.mid
      </attribute>
      <attribute name=“output.track.preset.layer” descriptor=“long” >
        1
      </attribute>
      <attribute name=“output.track.zone.probability” descriptor=“float” >
        1
      </attribute>
    </attributes>
    <segments>
      <map_controlled_segment silent_development=“yes” >
        <timemap>
          <enabled_time_interval enabled=“yes” duration=“8/1” />
          <enabled_time_interval enabled=“yes” duration=“8/1” />
          <enabled_time_interval enabled=“yes” duration=“8/1” />
          <enabled_time_interval enabled=“yes” duration=“8/1” />
        </timemap>
        <static_note_generator duration=“1/1” num_repeats=“8” >
          <note start_time=“3/4#121” duration=“#90” pitch=“C3”
            velocity=“122” />
        </static_note_generator>
        <static_note_generator duration=“1/1” num_repeats=“8” >
          <note start_time=“1/4#121” duration=“#90” pitch=“C3”
            velocity=“122” />
        </static_note_generator>
        <static_note_generator duration=“2/1” num_repeats=“4” >
          <note start_time=“3/4#121” duration=“#90” pitch=“C3”
            velocity=“122” />
          <note start_time=“3/2#361” duration=“#90” pitch=“E3”
            velocity=“122” />
        </static_note_generator>
        <static_note_generator duration=“1/1” num_repeats=“8” >
          <note start_time=“1/4#361” duration=“#90” pitch=“C3”
            velocity=“122” />
        </static_note_generator>
      </map_controlled_segment>
    </segments>
  </track>
    ... 2 track definitions removed for brevity ....
  <track midi_channel=“2” volume=“0.7874016” pan=“−1” >
    <name>14</name>
    <instrument>HHElecPiano2</instrument>
    <attributes>
      <attribute name=“output.track.loop.duration” descriptor=“long” >
        960
      </attribute>
      <attribute name=“output.track.loop.length” descriptor=“long” >
        8
      </attribute>
      <attribute name=“output.track.tonality-sequence.name” descriptor=“string” >
        pentripple10
      </attribute>
      <attribute name=“output.track.zone.probability” descriptor=“float” >
        0.5757012963294983
      </attribute>
    </attributes>
    <segments>
      <map_controlled_segment silent_development=“yes” >
        <timemap>
          <enabled_time_interval enabled=“yes” duration=“8/1” />
          <enabled_time_interval enabled=“yes” duration=“8/1” />
          <enabled_time_interval enabled=“yes” duration=“8/1” />
          <enabled_time_interval enabled=“no” duration=“8/1” />
        </timemap>
        <basic_note_generator gate_time=“0.9” >
          <hmsequence resolution=“720” num_block_repeats=“4” num_total_repeats=“100”
            start_fraction=“0.25” end_fraction=“0.4000000059604645” >
            <mod_vector num_copies=“1” >
              60, 120, 180, 240, 300, 360, 420, 480
            </mod_vector>
            <abstract_note_sequence num_copies=“1” >
              0, 1, 2, 3, 4, 5, 6, 7, 8, 9, 10, 9, 8, 7, 6, 5, 4, 3, 2, 1, 0
            </abstract_note_sequence>
          </hmsequence>
          <tonalities>
            <tonality name=“E5ripple01” root_note=“E4” duration=“8/1” />
            <tonality name=“E5ripple02” root_note=“E4” duration=“8/1” />
            <tonality name=“E5ripple03a” root_note=“D4” duration=“8/1” />
            <tonality name=“E5ripple05” root_note=“C4” duration=“8/1” />
            <tonality name=“E5ripple07” root_note=“D4” duration=“8/1” />
            <tonality name=“E5ripple08” root_note=“E4” duration=“8/1” />
          </tonalities>
          <rhythm>
            <note duration=“#120” />
          </rhythm>
          <velocities>
            <hmsequence resolution=“720” num_block_repeats=“4” num_total_repeats=“100”
              start_fraction=“0.2000000029802322” end_fraction=“0.833329975605011” >
              <mod_vector num_copies=“1” >
                60, 180, 300, 420, 480, 360, 240, 120
              </mod_vector>
              <velocity_sequence num_copies=“1” >
                63, 66, 69, 71, 74, 77, 74, 71, 69, 66, 63, 60, 57, 55, 52, 49, 52, 55, 57, 60, 63
              </velocity_sequence>
            </hmsequence>
          </velocities>
        </basic_note_generator>
      </map_controlled_segment>
    </segments>
  </track>
  <track midi_channel=“3” volume=“0.6299213” pan=“1” >
    <name>17</name>
    <instrument>HHLeadSynth1</instrument>
    <attributes>
      <attribute name=“output.track.loop.duration” descriptor=“long” >
        240
      </attribute>
      <attribute name=“output.track.loop.length” descriptor=“long” >
        1
      </attribute>
      <attribute name=“output.track.tonality-sequence.name” descriptor=“string” >
        pentripple10
      </attribute>
      <attribute name=“output.track.zone.probability” descriptor=“float” >
        0.5498741865158081
      </attribute>
    </attributes>
    <segments>
      <map_controlled_segment silent_development=“yes” >
        <timemap>
          <enabled_time_interval enabled=“yes” duration=“8/1” />
          <enabled_time_interval enabled=“no” duration=“8/1” />
          <enabled_time_interval enabled=“yes” duration=“8/1” />
          <enabled_time_interval enabled=“yes” duration=“8/1” />
        </timemap>
        <basic_note_generator velocity=“63” >
          <hmsequence resolution=“720” num_block_repeats=“4” num_total_repeats=“400”
            start_fraction=“0.25” end_fraction=“0.4000000059604645” >
            <mod_vector num_copies=“1” >
              60
            </mod_vector>
            <abstract_note_sequence num_copies=“1” >
              5, 6, 7, 8, 9, 10, 9, 8, 7, 6, 5, 4, 3, 2, 1, 0, 1, 2, 3, 4, 5
            </abstract_note_sequence>
          </hmsequence>
          <tonalities>
            <tonality name=“E5ripple01” root_note=“E4” duration=“8/1” />
            <tonality name=“E5ripple02” root_note=“E4” duration=“8/1” />
            <tonality name=“E5ripple03a” root_note=“D4” duration=“8/1” />
            <tonality name=“E5ripple05” root_note=“C4” duration=“8/1” />
            <tonality name=“E5ripple07” root_note=“D4” duration=“8/1” />
            <tonality name=“E5ripple08” root_note=“E4” duration=“8/1” />
          </tonalities>
          <rhythm>
            <note duration=“#240” />
            <note duration=“#240” />
            <note duration=“#240” />
            <note duration=“#240” />
          </rhythm>
          <gate_times>
            <hmsequence_float resolution=“720” num_block_repeats=“4” num_total_repeats=“400”
              start_fraction=“0.1666599959135056” end_fraction=“0.75” >
              <mod_vector num_copies=“1” >
                60
              </mod_vector>
              <percentage_sequence num_copies=“1” >
                55, 59, 63, 67, 71, 75, 79, 83, 87, 91, 95
              </percentage_sequence>
            </hmsequence_float>
          </gate_times>
        </basic_note_generator>
      </map_controlled_segment>
    </segments>
  </track>
      ... remaining track definitions removed for brevity ....
</tune>
```

Two XML files representing complete tune definitions are illustrated in Table 5 below. The definitions in Table 5 are similar to those in Table 4, but represent a complete tune. The “static_note_generator” and “note” tags permit the representation of pre-recorded rhythmic sections (e.g., a bass drum part, etc.).

One or more spreadsheets can be used to configure the software to generate a variety of different musical styles. For example, Tables 6-11 are provided below to provide a description of salient parts the present invention illustrated in Table 5. However, for the sake of clarity, a full description of each section of Table 5 will not be provided. With reference to Table 6, a global section (e.g., see, Table 6) defines parameters that apply to the tune overall. As many of these parameters are self explanatory, for the sake of clarity, a further description thereof will not be given.

TABLE 6
@GLOBAL

| | |
|---|---|
| Min tempo | 85 |
| Max tempo | 100 |
| Min instruments | 5 |
| Max instruments | 11 |
| Min obligatory instruments | 1 |
| Max primary bass tracks | 1 |
| Max unison bass tracks | 0 |
| Bass volume adjust | 1.4 |
| Max HM drums | 0 |
| Min additional tracks | 1 |
| Max additional tracks | 4 |
| Min syncopated tracks | 0 |
| Max syncopated tracks | 2 |
| Syncopated bass selection | 2 |
| adjustment | |

# we increase the min number of playing tracks to allow for the 4 preset drum tracks al

[symbol]

| Min playing tracks | 7 | |
|---|---|---|
| Num zones | 4 | |
| Zone length seconds | 15 | |
| Preset drum layers | 4 | |
| Preset drum instrument | HHDrums | |
| Preset drum volume adjust | 1 | |
| Preset drums layer 0 | hiphop/HH_KICKSNARE_PRESETS | 1.0 1.0 |
| Preset drums layer 1 | hiphop/HH_GHOST_KICKSNARE_PRESETS | 1.0 1.0 |
| Preset drums layer 2 | hiphop/HH_HiHAT_PRESETS | 1.0 1.0 |
| Preset drums layer 3 | hiphop/HH_PERC_PRESETS | 0.5 0.8 |

[symbol]

indicates data missing or illegible when filed

With reference to Table 7, the loop duration config (LDC) section specifies how the loops which compose the harmonic maths part of the melody are configured. It specifies the duration of a “loop” (a single iteration of the harmonic maths process), how many notes will be played in each iteration, how many times each iteration will be repeated, the duty cycle (the amount of notes compared to rests making up the duration of an iteration), and what portion of a complete harmonic maths cycle the process can cover.

TABLE 7
@LDCLIST

| | | | | Cycle | | Allowed loop |
|---|---|---|---|---|---|---|
| | Num block | Default gate | Allowed duty | fraction | Allowed loop | lengths rapid |
| #Loop duration | repeats | time | cycles | range | lengths | instruments |
| 240 | 4 | 0.9 | 100 50 25 | 0.2 0.8 | 1 2 | 1 2 |
| 480 | 4 | 0.9 | 100 50 25 | 0.2 0.8 | 1 2 4 | 1 2 4 |
| 960 | 4 | 0.9 | 100 50 25 | 0.4 0.8 | 1 2 4 8 | 1 2 4 8 |
| 1920 | 4 | 0.9 | 100 50 25 | 0.4 1.0 | 1 2 4 8 16 | 1 2 4 8 16 |
| 3840 | 4 | 0.9 | 100 50 25 | 0.4 1.0 | 2 4 8 16 | 2 4 8 16 |
| 7680 | 4 | 0.9 | 100 50 25 | 0.4 1.0 | 4 8 16 | 4 8 16 |
| 15360 | 2 | 1.0 | 100 50 | 0.6 1.0 | 8 16 32 | 8 16 32 |

With reference to Table 5, the LDCMAPS and LOOPLENGTHFILTERS sections describe which harmonic maths parameters may be selected from the space of possible loop duration and loop length values.

For example, with reference to Table 8 below, the rows represent note length values and the columns denote loop durations. The first value at each location (i.e., row, col.) is the loop length and the second the note length produced by dividing the loop duration by the loop length. Thus, with reference to row 2, col. 4, the loop length is 2, and the note length is 1920. As shown, each row can have notes of the same length but different loop lengths.

TABLE 8

| 480 | | 960 | | 1920 | | 3840 | | 7680 | |
|---|---|---|---|---|---|---|---|---|---|
| | | | | | | | | 1 | 7680 |
| | | | | | | 1 | 3840 | 2 | 3840 |
| | | | | | | | | 3 | 2560 |
| | | | | 1 | 1920 | 2 | 1920 | 4 | 1920 |
| | | | | | | 3 | 1280 | 6 | 1280 |
| | | 1 | 960 | 2 | 960 | 4 | 960 | 8 | 960 |
| | | | | 3 | 640 | 6 | 640 | 12 | 640 |
| 1 | 480 | 2 | 480 | 4 | 480 | 8 | 480 | 16 | 480 |
| | | 3 | 320 | 6 | 320 | 12 | 320 | 24 | 320 |
| 2 | 240 | 4 | 240 | 8 | 240 | 16 | 240 | *32 | 240 |
| 3 | 160 | 6 | 160 | 12 | 160 | 24 | 160 | *48 | 160 |
| 4 | 120 | 8 | 120 | 16 | 120 | *32 | 120 | | |
| 6 | 80 | 12 | 80 | 24 | 80 | *48 | 80 | | |
| 8 | 60 | 16 | 60 | *32 | 60 | | | | |
| *12 | 40 | *24 | 40 | *48 | 40 | | | | |
| *16 | 30 | *32 | 30 | | | | | | |

The LDCMAPS section illustrates how loop duration and loop length combinations can be picked from the Table 8. These values are better illustrated with reference to Table 8 below. As used herein, names for settings have been arbitrarily set to include such names as “Manhattan” which allows any combination of values to be selected. Other names of settings used herein include “plus,” “thick plus,” “multiple column,” “adjacent column,” “column”, and “column subset.”

TABLE 9

| | |
|---|---|
| 1. | Manhattan means no restriction on the values that can be picked |
| 2. | multiple column means that more than one column is selected and |
| | values can only be picked from these |
| 3. | adjacent column means that two adjacent columns are chosen and |
| | values can only be picked from them |
| 4. | plus means that one row and one column is selected, as in |
| | a + shape |
| 5. | hash means that 2 rows and 2 columns are selected, as in a # shape |
| 6. | column means a single column is selected |
| 7. | column subset means a part of a column is selected |

With reference to the @LDCMAPS variable, this variable indicates allowed map types: multiple-column adjacent-column plus manhattan thick-plus hash column-subset column. Other names of the map types are defined in Table 10.

With reference to the LOOPLENGTHFILTERS section, this section places further limits on the loop duration and loop length parameters that can be selected. For example, as shown in Table 10 below, only powers of two are allowed for the loop lengths

TABLE 10
@LOOPLENGTHFILTERS

| #NAME | Loop lengths |
|---|---|
| Power 2 | 1 2 4 8 16 32 |

The remainder of the spreadsheet contains a number of parameters for each instrument, these are arranged as columns with one instrument per row and are further described with reference to Table 11 below.

TABLE 11

| | |
|---|---|
| 1. | name - the name of the instrument, used to refer to it in the XML file |
| 2. | category - the category (e.g., piano, bass, synthesizer, drum, etc.) - used to select an |
| | instrument from a particular category |
| 3. | enabled? - indicates whether the instrument is used |
| 4. | Rapid? - indicates whether the instrument be used for very fast sections |
| 5. | Obligatory? - indicates whether the instrument appears in the tune |
| 6. | Unison bass instrument - indicates whether the instrument can be used to double up a |
| | bass line with the bass instrument |
| 7. | HM gate time enabled - indicates whether harmonic maths can be used to vary the |
| | proportion of a note that an instrument actually plays for |
| 8. | lowest register - indicates the lowest octave the instrument can play in |
| 9. | highest register - what's the highest octave this instrument can play in |
| 10. | instrument frequency - likelihood of selection of the instrument for a certain track |
| 11. | zone probability range - when deciding whether to let a track using the instrument play in |
| | any given zone how high should the probability be that the track is chosen. (When an |
| | instrument is chosen for a track, a zone probability controls how likely the track is to play |
| | in any given zone. This ensures that some instruments are more (or less - if desired) |
| | likely to play then others- for example, it may be desirable to play in oboe occassionally |
| | and to play a piano in almost every tune.) |
| 12. | allowable loop lengths - an allowable loop lengths that the instrument can use |
| 13. | min note length - what's the shortest note the instrument can play |
| 14. | max note length - what's the longest note the instrument can play |

Examples of fact definitions for the input data streams as expressed in CLIPS is shown in Table 12 below.

TABLE 12

```
deftemplate input.image.luminance.vector
    (slot index
        (type INTEGER)
        (default 1))
    (multislot value
        (type FLOAT)
        (range 0.0 1.0))
)
(deftemplate input.image.colourfulness
    (slot value
        (type FLOAT)
        (range 0.0 1.0)
        (default ?DERIVE))
)
(deftemplate input.voice.fingerprint.vector
    (slot index
        (type INTEGER)
        (default 1))
    (multislot value
        (type FLOAT)
        (range 0.0 1.0)
        (default ?DERIVE))
)
(deftemplate input.sound.fingerprint.vector
    (slot index
        (type INTEGER)
        (default 1))
    (multislot value
        (type FLOAT)
        (range 0.0 1.0)
        (default ?DERIVE))
)
(deftemplate input.rhythm.fingerprint.vector
    (slot index
        (type INTEGER)
        (default 1))
    (multislot value
        (type FLOAT)
        (range 0.0 1.0)
        (default ?DERIVE))
)
```

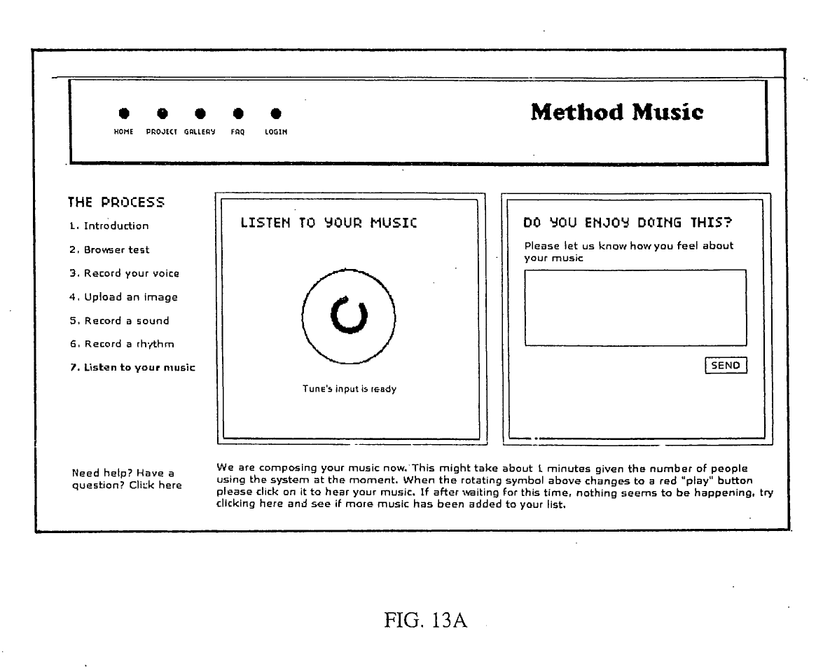

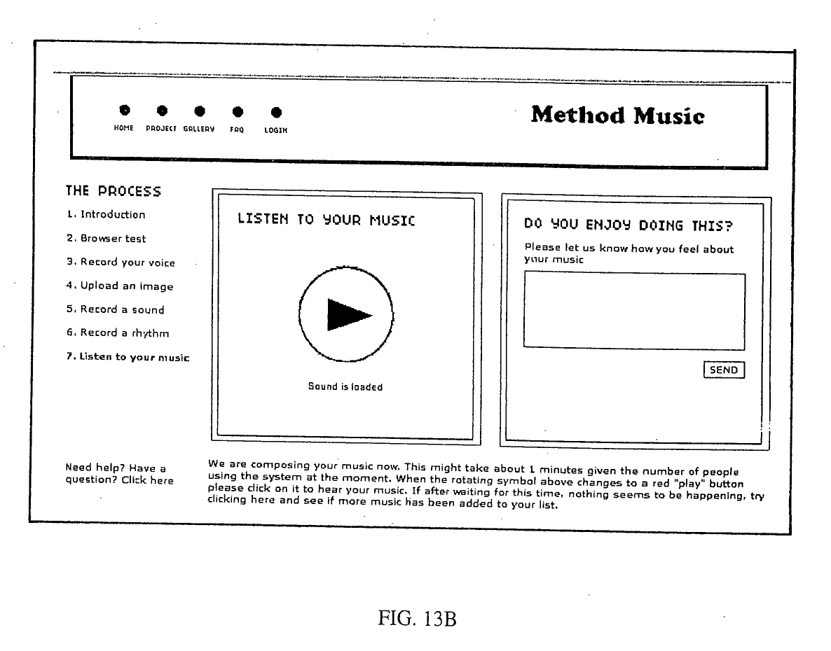

A definition of the track fact which is the main output of the composition engine is shown in FIG. 13 below.

TABLE 13

```
(deftemplate track
  (slot id
    (type INTEGER)
    (default ?NONE))
  (slot status
    (type SYMBOL)
    (allowed-symbols CREATED HAVE_TONALITY_ORDER
HAVE_ZONE_PROFILE HAVE_ZONES HAVE_RHYTHM
COMPLETE)
    (default ?NONE))
  (slot instrument
    type STRING
    (default ?NONE))
  (slot isBass
    (type INTEGER)
    (default 0))
  (slot volume
    (type FLOAT)
    (default 0.75))
  (slot pan
    (type FLOAT)
    (default 0.0))
  (slot gateTime
    (type FLOAT)
    (default 0.9))
  (multislot zones
    (type INTEGER)
    (default ?DERIVE))
  (slot zoneProfile
    (type SYMBOL)
    (default undefined))
  (slot tonalities.baseOctave
    (type INTEGER)
    (default 0))
  (multislot tonalities.roots
    (type INTEGER)
    (default ?DERIVE))
  (multislot tonalities.octaves
    (type INTEGER)
    (default ?DERIVE))
  (multislot tonalities.tonalities
    (type INTEGER)
    (default ?DERIVE))
  (slot tonalityOrder
    (type INTEGER)
    (default 0))
  (slot tonalityName
    (type STRING)
    (default ?DERIVE))
  (multislot tonalityAdjustRange
    (type INTEGER)
    (default ?DERIVE))
  (multislot hm.sequence
    (type INTEGER)
    (default 5 6 7 8 9 10 9 8 7 6 5 4 3 2 1 0 1 2 3 4 5))
  (multislot hm.modifiers
    (type INTEGER)
    (default ?DERIVE))
  (slot hm.velocity.enabled
    (type INTEGER)
    (default 1))
  (slot hm.velocity.cycleStart
    (type FLOAT)
    (default 0.22))
  (slot hm.velocity.cycleEnd
    (type FLOAT)
    (default 0.28))
  (multislot hm.velocity.sequence
    (type INTEGER)
    (default ?DERIVE))
  (multislot hm.velocity.modifiers
    (type INTEGER)
    (default ?DERIVE))
  (slot hm.gateTime.enabled
    (type INTEGER)
    (default 0))
  (slot hm.gateTime.cycleStart
    (type FLOAT)
    (default 0.22))
  (slot hm.gateTime.cycleEnd
    (type FLOAT)
    (default 0.28))
  (multislot hm.gateTime.sequence
    (type INTEGER)
    (default ?DERIVE))
  (multislot hm.gateTime.modifiers
    (type INTEGER)
    (default ?DERIVE))
  (slot hm.cycleStart
    (type FLOAT)
    (default 0.22))
  (slot hm.cycleEnd
    (type FLOAT)
    (default 0.28))
  (slot hm.numBlockRepeats
    (type INTEGER)
    (default 4))
  (slot hm.numIterations
    (type INTEGER)
    (default 120))
  (slot hm.resolution
    (type INTEGER)
    (default 720))
  (slot hm.loop-duration
    (type INTEGER)
    (default ?DERIVE))
  (slot hm.loop-length
    (type INTEGER)
    (default ?DERIVE))
  (slot silentDevelopment
    (type INTEGER)
    (default ?DERIVE))
  (multislot rhythm
    (type INTEGER)
    (default ?DERIVE))
  (slot zoneProbability
    (type FLOAT)
    (range 0.0 1.0)
    (default 0.5))
  (slot zonePlayCount
    (type INTEGER)
    (default 0))
  (slot dutyCycle
    (type INTEGER)
    (default 100))
)
```

A primary function of the wrapper software is to take the input streams and create instances of the input facts. The inference engine engine runs and produces a number of facts including several instances of the track fact defined above. The wrapper software then converts the output facts into an XML representation for the next stage. These CLIPS functions define how to extract values from the input facts as is illustrated below with reference to Table

TABLE 14

```
(deffunction getValueFromIndexedInputFact (?iv)
  (bind ?index (fact-slot-value ?iv index))
  (bind ?value (nth ?index (fact-slot-value ?iv value)))
  (if (>= ?index (length (fact-slot-value ?iv value))) then
    (bind ?index 1)
  else
    (bind ?index (+ ?index 1))
  )
  (modify ?iv (index ?index))
  (return ?value)
)
(deffunction getInputImageLuminanceVectorValue ( )
  (bind ?iv
    (nth 1 (find-fact ((?fct input.image.luminance.vector)) TRUE))
  )
  (return (getValueFromIndexedInputFact ?iv))
)
(deffunction getInputImageColourfulness ( )
  (bind ?fct
    (nth 1 (find-fact ((?fct input.image.colourfulness)) TRUE))
  )
  (return (fact-slot-value ?fct value))
)
(deffunction getInputVoiceFingerprintVectorValue ( )
  (bind ?iv
    (nth 1 (find-fact ((?fct input.voice.fingerprint.vector)) TRUE))
  )
  (return (getValueFromIndexedInputFact ?iv))
)
(deffunction getInputSoundFingerprintVectorValue ( )
  (bind ?iv
    (nth 1 (find-fact ((?fct input.sound.fingerprint.vector)) TRUE))
  )
  (return (getValueFromIndexedInputFact ?iv))
)
(deffunction getInputRhythmFingerprintVectorValue ( )
  (bind ?iv
    (nth 1 (find-fact ((?fct input.rhythm.fingerprint.vector))
TRUE))
  )
  (return (getValueFromIndexedInputFact ?iv))
)
(deffunction convertFloatToIntegerRange (?input ?min ?max)
  (return (integer
    (clip (round (+ ?min (− (* (+ (− ?max ?min) 1) ?input) 0.5)))
?min ?max)
  ))
)
```

Examples of the input mapper functions called at various decision points are shown in Table 15 below. The input mapper functions can take a value from one of the input streams and convert it into a desired output format.

```
TABLE 15
(deffunction inputFloatChooseTonalityOrder ( )
    (bind ?value (getInputRhythmFingerprintVectorValue))
    (printout wtrace “inputFloatChooseTonalityOrder = ” ?value crlf)
    (return ?value)
)
  (deffunction inputFloatChooseCycleFraction1 ( )
    (bind ?value (getInputImageLuminanceVectorValue))
    (printout wtrace “inputFloatChooseCycleFraction1 = ” ?value crlf)
    (return ?value)
)
  (deffunction inputFloatChooseCycleFraction2 ( )
```

| | |
|---|---|
| (bind ?value (/ (+ | (getInputSoundFingerprintVectorValue) |
| | (getInputVoiceFingerprintVectorValue)) 2)) |

```
    (printout wtrace “inputFloatChooseCycleFraction2 = ” ?value crlf)
    (return ?value)
)
  (deffunction inputIntegerMakeBeats (?min ?max)
    (bind ?value (convertFloatToIntegerRange
(getInputSoundFingerprintVectorValue) ?min ?max))
    (printout wtrace “inputIntegerMakeBeats = ” ?value crlf)
    (return ?value)
)
(deffunction inputIntegerPickLDC (?min ?max)
    (bind ?value (convertFloatToIntegerRange
(getInputImageLuminanceVectorValue)  ?min ?max))
    (printout wtrace “inputIntegerPickLDC = ” ?value crlf)
    (return ?value)
)
(deffunction inputFloatPickAdjacent ( )
    (bind ?value (getInputImageLuminanceVectorValue))
    (printout wtrace “inputFloatPickAdjacent = ” ?value crlf)
    (return ?value)
)
```

An example of the portrait process from a sitter's (e.g., a user's) perspective will now be described in more detail below.

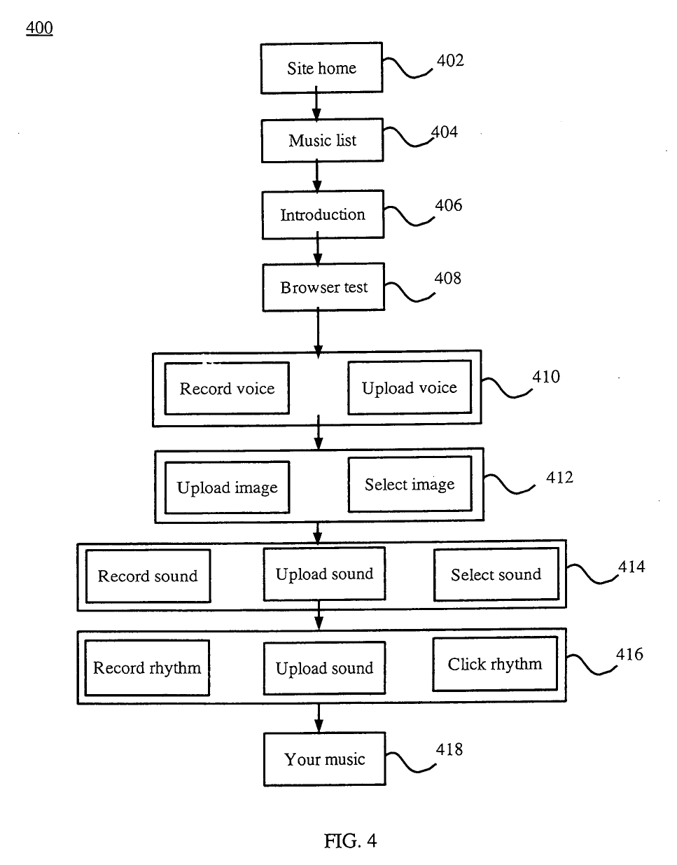

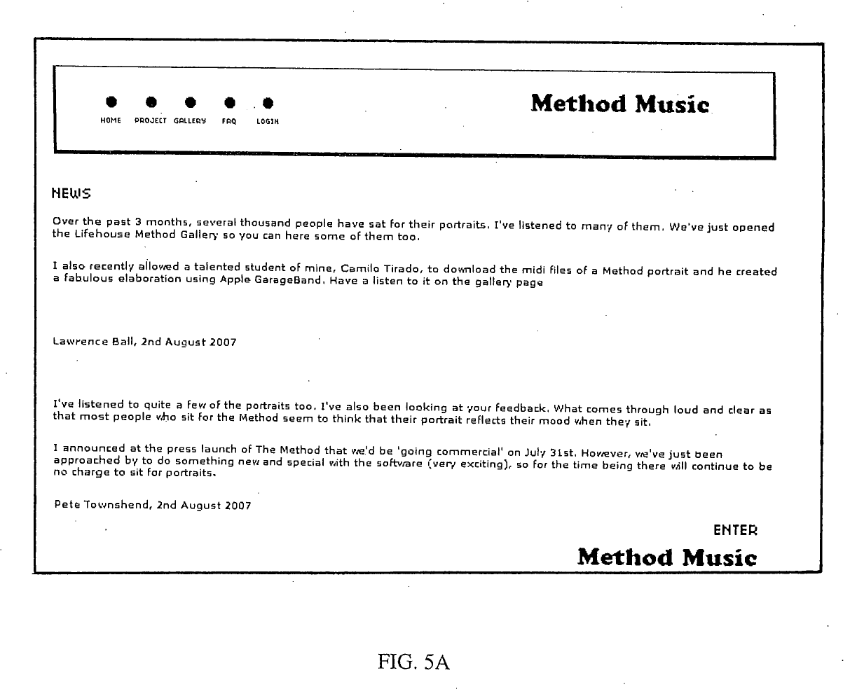

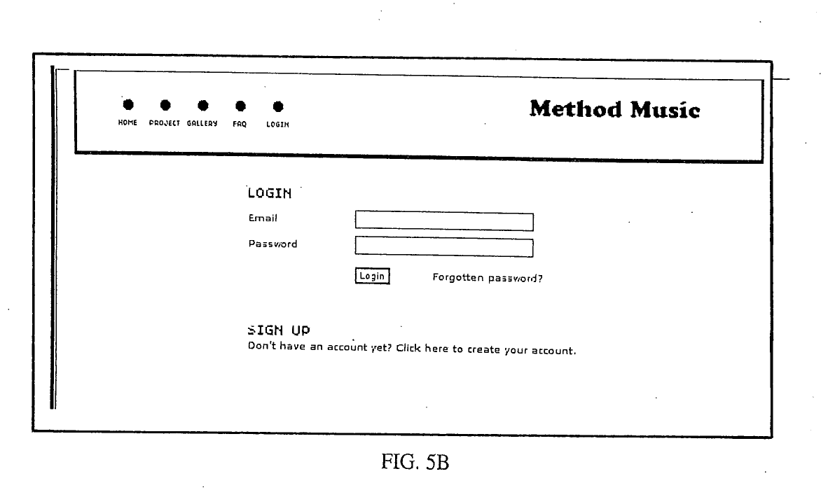

A flowchart illustrating a portrait sitting process according to the present invention is shown in FIG. 4. The process can include one or more of steps 402, 404, 406, 408, 410, 412, 414, 416, and 418, as shown. In step 402, a user can access a home page and can log in to the system using, for example, identification information such as an account name and/or a password, or other identification such as biometric information (e.g., a fingerprint, an iris print, a face print, an identification card, an RFID (radio frequency identification), etc., can also be used. A homepage and a log-in page (e.g., to complete an authorization) are illustrated in FIGS. 5A and 5B, respectively. As shown, an account setup option may be provided in, for example, the log-in page (or in the homepage, etc.), as desired. After a user is authorized, the process continues to step 404. Although not shown, a user may be automatically authorized (e.g., in the case of access using a mobile station such as, for example, a cellular telephone). After step 402 is completed, the process continues to step 404.

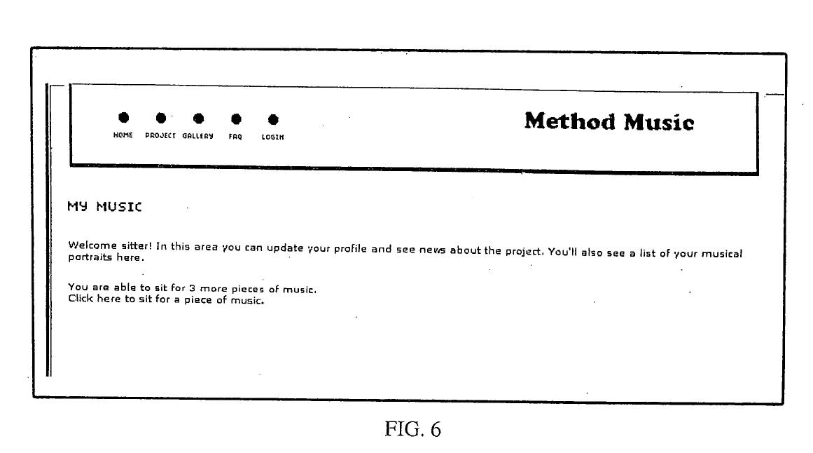

In step 404, a music list and/or a user profile is output (e.g., visually and/or audibly) for use by the user. An example of a visual output (e.g., a webpage) including information informing the user of review and/or update information is shown in FIG. 6. After step 404 is completed, the process continues to step 406.

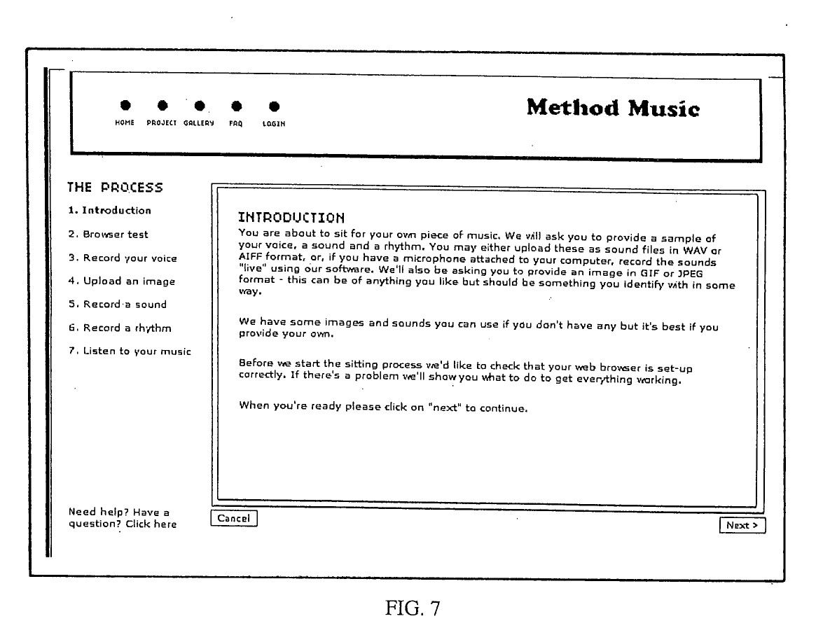

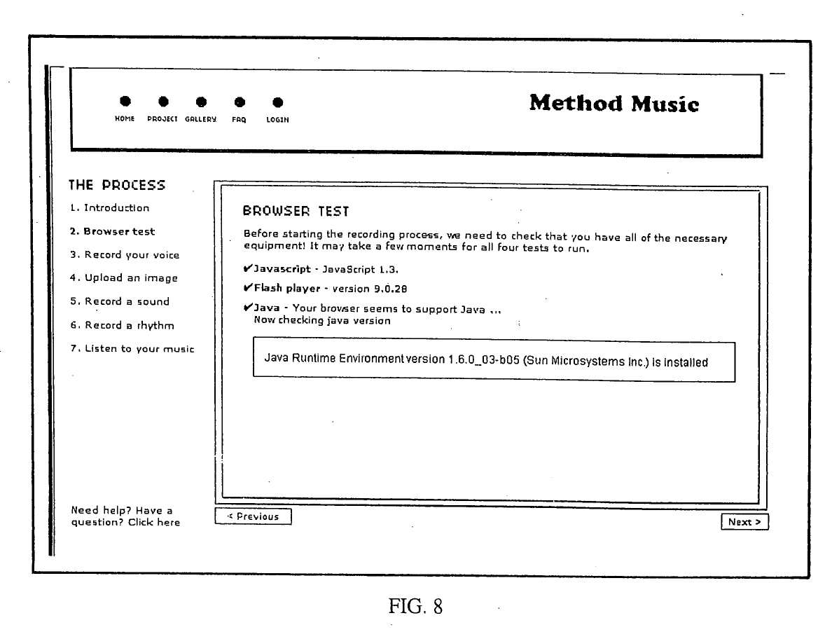

In step 406, introduction information (e.g., an introduction screen or webpage) 407 such as, for example, that which is shown in FIG. 7, can be output via, for example, a display. The introduction information can include information related to a user's relative location in the process, optional selections, etc. After step 406 is completed, the process continues to step 408.

In step 408, an optional browser test is performed. The system can then analyze the results of the browser test and determine which settings may be set. For example, if a user does not have a microphone input and cannot record a sound file, then, for example, up to three (or any other suitable number, as desired) pre-recorded sound files can be selected by the user for use by the system. Further, if using known software/hardware configurations (e.g., a kiosk, etc.), this step may be omitted, as desired. After completing step 408, the process continues to step 410.

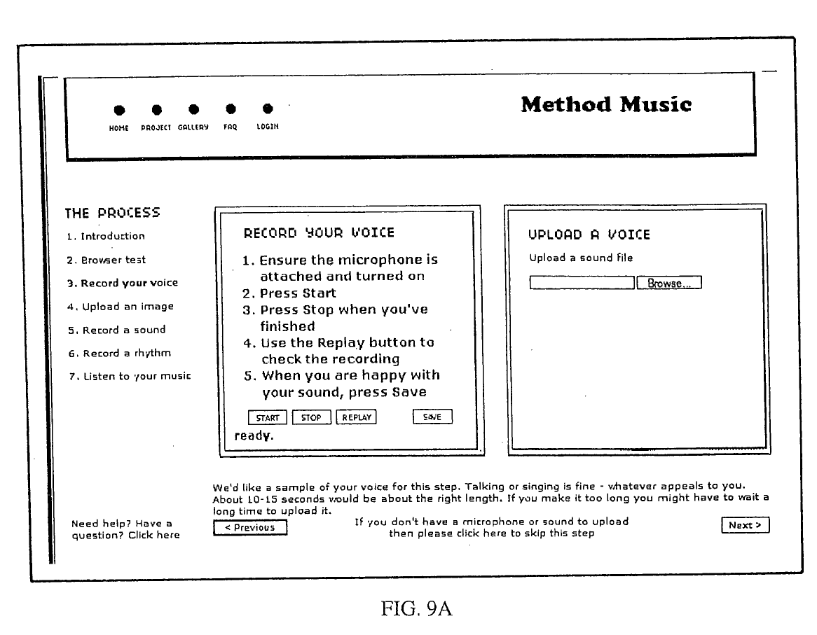

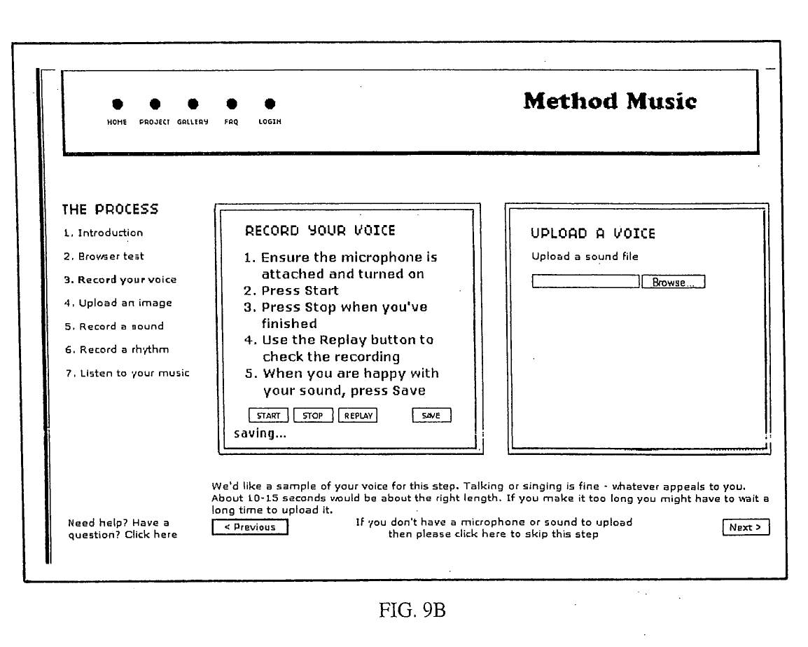

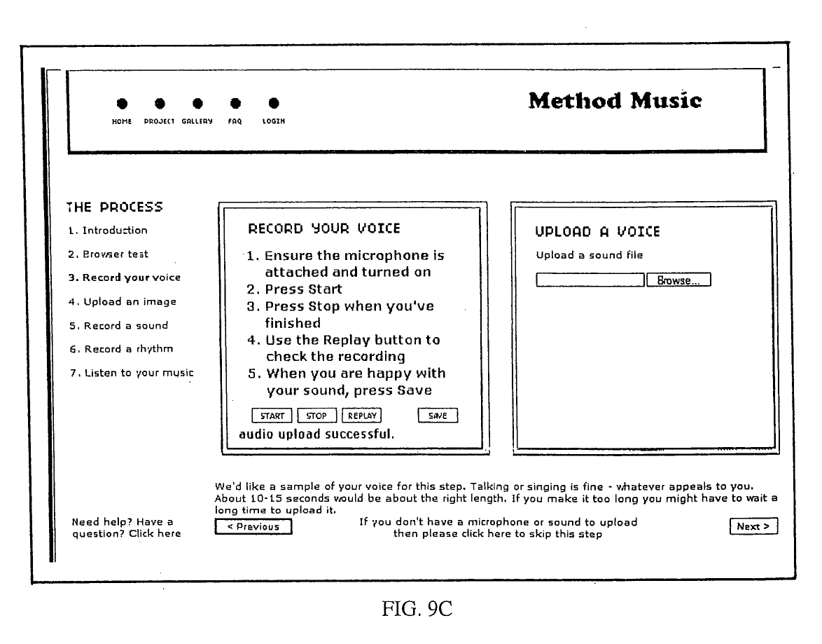

In step 410, recording information such as is shown in FIGS. 9A-9C can be output e.g., via the display. The recording information can include information for selecting to record a voice and/or to select a pre-recorded voice (or sound), as shown. Further, if the system determines (e.g., in step 408 above) that a user does not have a microphone to record a voice (or audible file), the system can provide a user with pre-recorded voices or sounds for selection by the user. In other words, the system may make determinations and/or selections based upon the determination in step 408. With reference to FIGS. 9A-9C, after one or more appropriate inputs are selected, the system processes the information and thereafter continues to step 412.

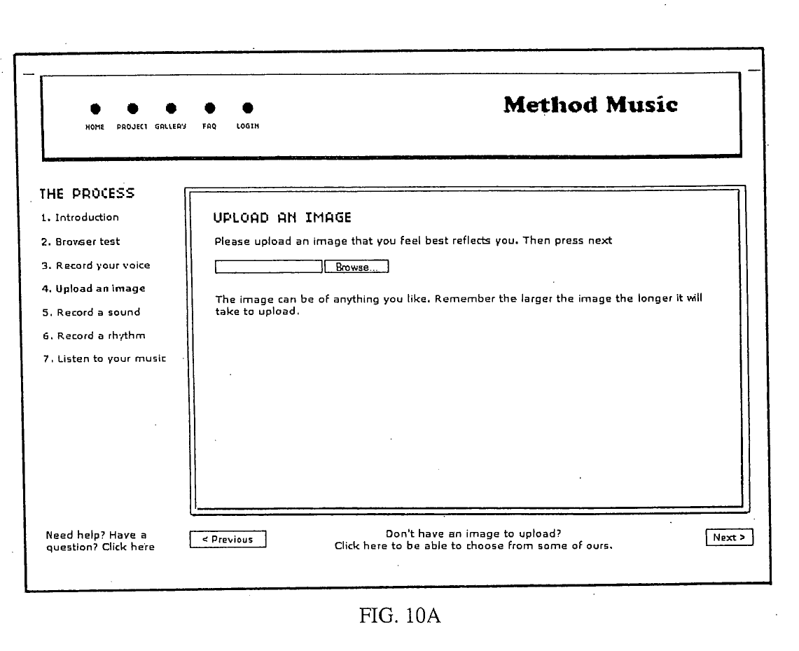

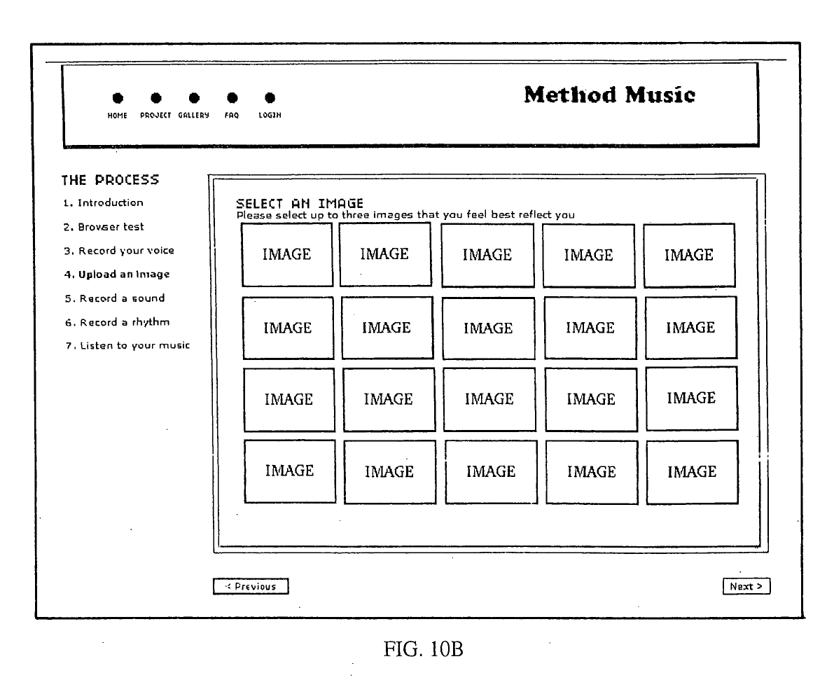

In step 412, information requesting an upload or a selection of an image is output for the user's selection as shown in FIGS. 10A and 10B. A user can select to upload or save an image, and corresponding information is processed by the system. After processing the user's selection, the process continues to step 414. Although not shown, the system can determine what type of selection was input for later use.

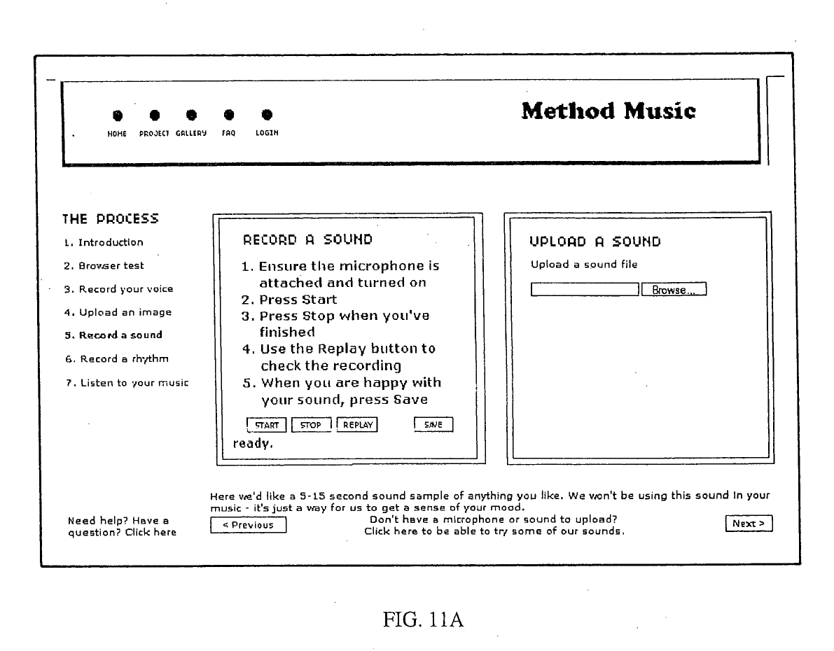

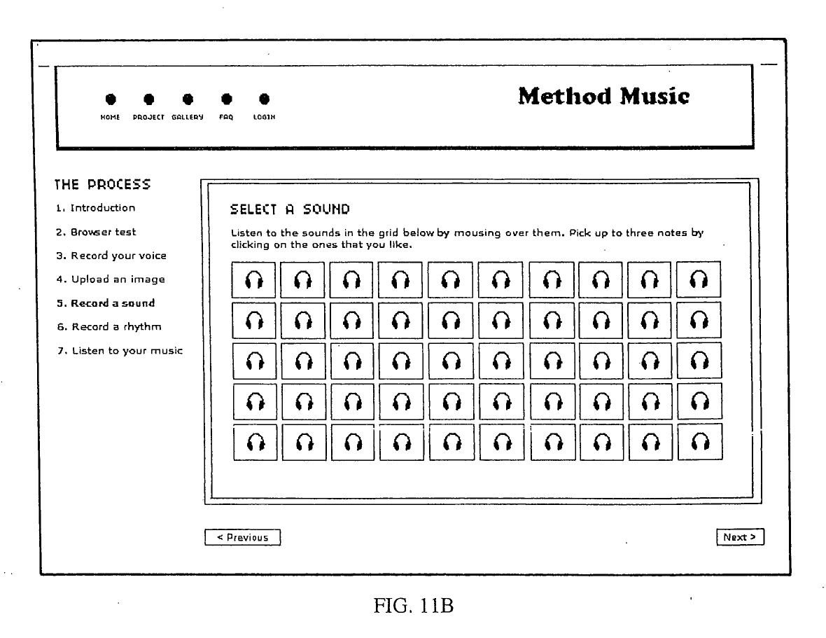

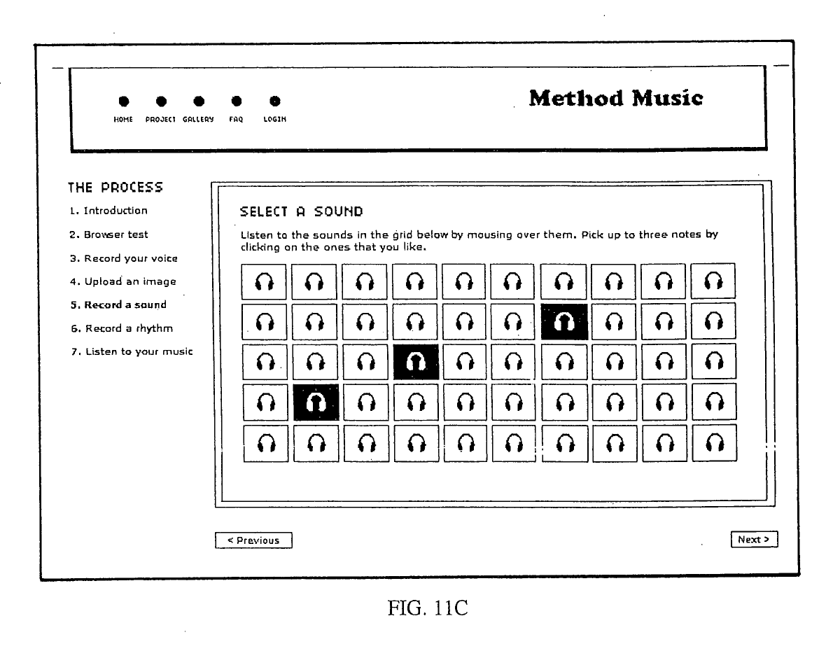

In step 414, information requesting that a sound be recorded, uploaded, and/or selected can be output for a user's selection as is shown in FIGS. 11A-11C. After a user has selected to record, upload, and/or select sounds, the system processes the input information and the process continues to step 416.

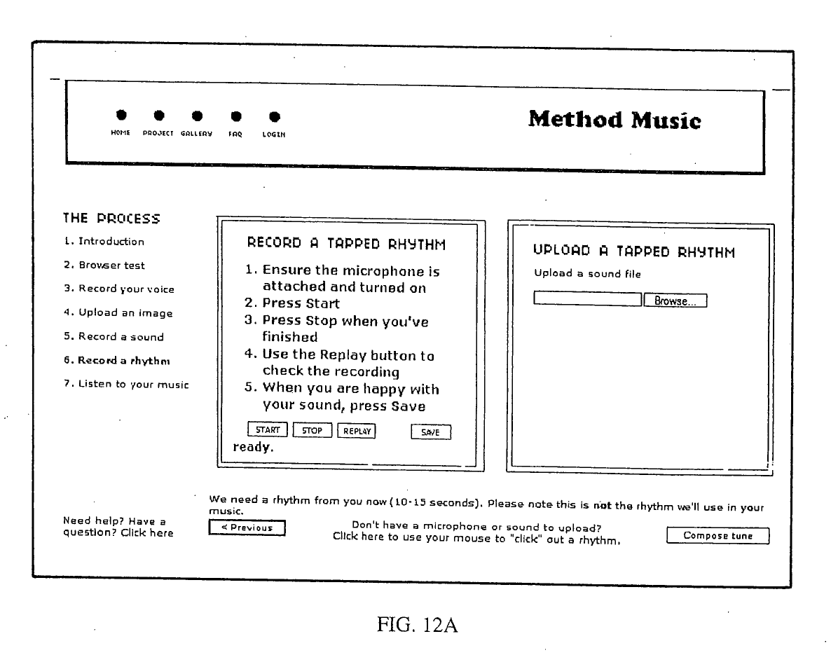

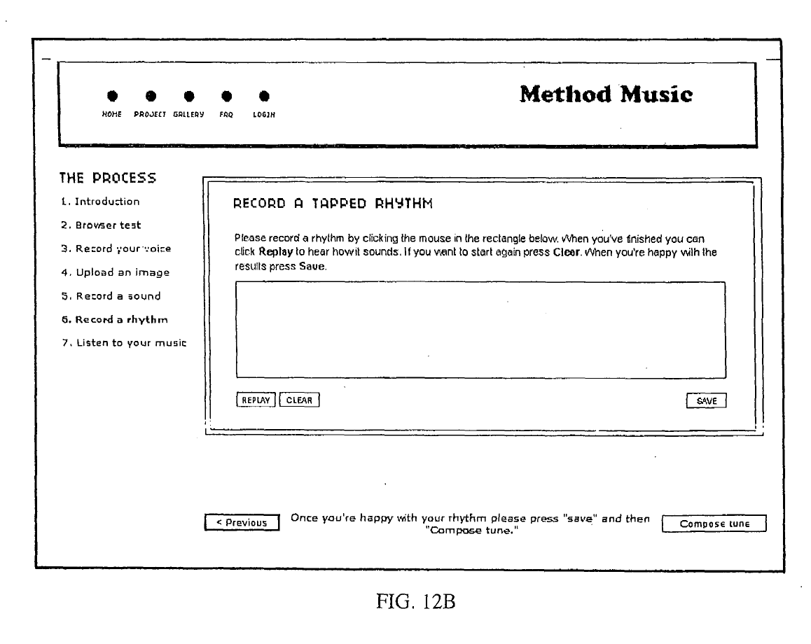

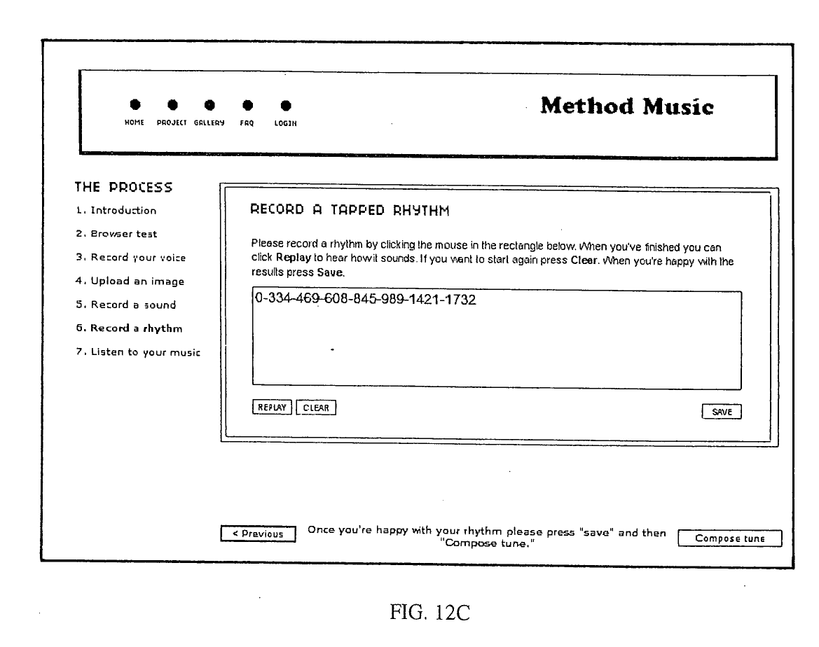

In step 416, information requesting that the user record, upload, and/or click a rhythm, such as is shown in FIGS. 12A-12C, can be displayed for the user's selection. After the user records, uploads, and/or clicks a rhythm, the system processes the user's input and the process continues to step 418.

In step 418, the system composes music corresponding to the user's inputs and thereafter provide means for playing the user's music as is shown in FIGS. 13A and 13B, respectively.

If one or more steps in the process shown in the flowchart of FIG. 4 is deleted, the system may select to continue to perform other steps, as desired. Further, if using a device with a limited or no graphic capability, such as, for example, an MS, the system may use an audible information means rather than graphic information means to inform the user and/or receive entries from a user. Accordingly, the system can be compatible with mobile devices such as, for example, MSs, etc. Further, the system may be accessed using different access stations. For example, a user may interface during steps 402-416 using a PC and may thereafter, for example, play back music (e.g., see, 418) using one or more MSs.

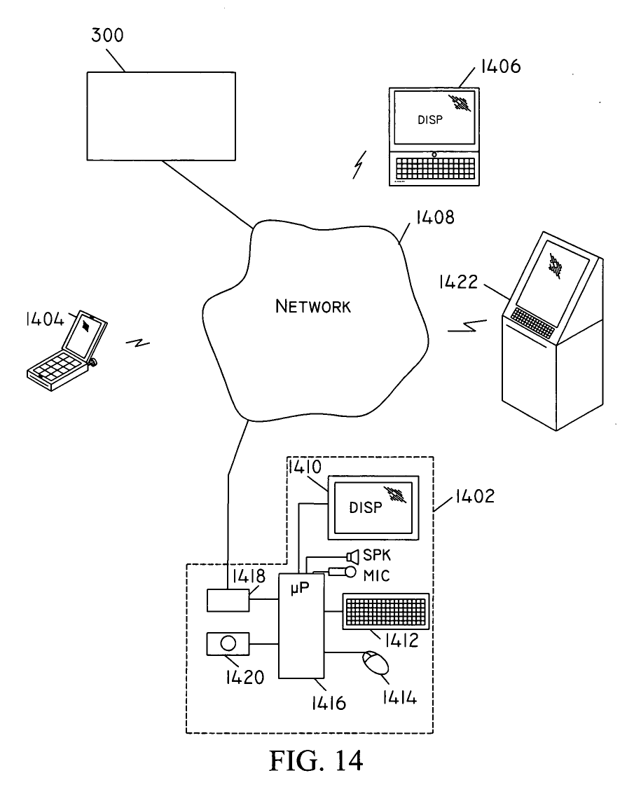

A block diagram illustrating the system including a network according to an embodiment of the present invention is shown in FIG. 14. The system 300 can communicate with MSs 1404 (e.g., a cellular telephone) and 1406 (e.g., a Blackberry™-type device), a PC 1402, and/or a kiosk 1422 which are in wired and/or wireless communication with one or more networks 1408 such as, for example, the Internet, a cellular communication network, etc. Each of the PC 1402, the kiosk 1422 and the MSs 1404 and 1406 includes one or more of a display (e.g., a touch-screen display, an LCD (liquid crystal display) display, etc.), a speaker (SPK), a microphone (MIC), and a user input device such as, for example, the touch-screen display, a keyboard (KB), and/or a pointing device, this is more clearly illustrated with reference to the PC 1402. Accordingly, for the sake of clarity only a description of the PC 1402 will be given. The PC 1402 can include one or more of a controller 1416, a modem 1418, an image capturing device 1420, a display 1410, the SPK, the MIC, user input devices such as, for example a touch screen (e.g., on the display 1410), a KB 1412, a pointing device such as, for example, a mouse 1414. The image capturing device 1420 can include a camera (e.g., for capturing video and/or still images, etc.). A controller 1416 controls the overall operation of the PC 1402. Although not illustrated, one or more elements of the system 300 can be located within or formed integrally with one or more of the MSs 1404 and 1406, the PC 1402, and/or the kiosk 1422. The MSs 1404 and 1406, the kiosk 1422, and the PC 1402 can send and/or receive information from the system 300, as required.

Certain additional advantages and features of this invention may be apparent to those skilled in the art upon studying the disclosure, or may be experienced by persons employing the novel system and method of the present invention.

While the invention has been described with a limited number of embodiments, it will be appreciated that changes may be made without departing from the scope of the original claimed invention, and it is intended that all matter contained in the foregoing specification and drawings be taken as illustrative and not in an exclusive sense.

What is claimed is:

1. A system for generating audio information, comprising:
one or more controllers which
input user information,
form one or more streams of information based upon the user information,
create a pattern in accordance with the user information, and
generate audio information based upon the pattern.

2. The system according to claim 1, wherein the user information comprises at least one of audio and visual data.

3. The system according to claim 2, wherein the audio data comprises at least one of an image, a voice, and a rhythm.

4. The system according to claim 1, wherein the one or more streams comprise floating point numbers.

5. The system according to claim 4, wherein the one or more streams range from 0 to 1.

6. The system according to claim 1, further comprising an interference engine which processes the one or more streams of information.

7. The system according to claim 6, wherein the pattern is based upon a musical composition corresponding to a music template.

8. The system according to claim 1, wherein the controller converts the generated audio information into audio information having a desired file format.

9. The system according to claim 2, wherein the desired file format comprises a MIDI file or a text file corresponding to a musical score.

10. A method for generating audio information using at least one controller, the method comprising the steps of:
inputting, using the at least one controller, user information;
forming, using the at least one controller, one or more streams of information based upon the user information;
creating, using the at least one controller, a pattern in accordance with the user information; and
generating, using the at least one controller, the audio information based upon the pattern.

11. The method according to claim 10, wherein the user information comprises at least one of audio and visual data.

12. The method according to claim 11, wherein the audio data comprises at least one of an image, a voice, and a rhythm.

13. The method according to claim 10, wherein the one or more streams comprise floating point numbers.

14. The method according to claim 13, wherein the one or more streams range from 0 to 1.

15. The method according to claim 13, further comprising processing, using an interference engine, the one or more streams of information.

16. The method according to claim 15, wherein the pattern is based upon a musical composition corresponding to a music template.

17. The method according to claim 10, further comprising converting, using the at least one controller, the generated audio information into audio information having a desired file format.

18. The method according to claim 11, wherein the desired file format comprises a MIDI file or a text file corresponding to a musical score.

19. A method performed by a system including at least one controller, the method comprising the steps of:
receiving, by the at least one controller, voice information;
inputting, by the at least one controller, image information;
receiving, by the at least one controller, at least one of sound information and rhythm information;
processing the received voice information, image information, and the at least one of sound information and rhythm information; and
forming a musical composition based upon the one or more of the received voice information, image information, sound information and rhythm information.

20. The method of claim 19, wherein the processing step comprises forming a string of floating point numbers based upon at least one of the voice, image, sound and rhythm information.
